(19) United States
(12) Patent Application Publication
(10) Pub. No.: US 2023/0142885 A1
(43) Pub. Date: May 11, 2023

(54) SELECTING NEURAL NETWORK ARCHITECTURES BASED ON COMMUNITY GRAPHS

(71) Applicant: X Development LLC, Mountain View, CA (US)

(72) Inventors: Sarah Ann Laszlo, Mountain View, CA (US); Hailey Anne Trier, El Paso, TX (US)

(21) Appl. No.: 17/524,574

(22) Filed: Nov. 11, 2021

(51) Int. Cl. G06N 3/06; G06N 3/04; G06F 16/901

(52) U.S. Cl. CPC G06N 3/061; G06N 3/04; G06F 16/9024

(57) ABSTRACT

In one aspect, there is provided a method performed by one or more data processing apparatus, the method including: obtaining data defining a connectivity graph that represents synaptic connectivity between multiple biological neuronal elements in a brain of a biological organism, where the connectivity graph includes: multiple nodes, and multiple edges that each connect a respective pair of nodes, determining a partition of the connectivity graph into multiple community sub-graphs by performing an optimization that encourages a higher measure of connectedness between nodes included within each community sub-graph relative to nodes included in different community sub-graphs, and selecting a neural network architecture for performing a machine learning task using multiple community sub-graphs determined by the optimization that encourages the higher measure of connectedness between nodes included within each community sub-graph relative to nodes included in different community sub-graphs.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes techniques for selecting a neural network architecture for performing a machine learning task based on community sub-graphs of a synaptic connectivity graph.

Throughout this specification, a “synaptic connectivity graph” can refer to a graph that represents a biological connectivity between neuronal elements in a brain of a biological organism. A “neuronal element” can refer to an individual neuron, a portion of a neuron, a group of neurons, or any other appropriate biological neuronal element, in the brain of the biological organism. The synaptic connectivity graph can include multiple nodes and edges, where each edge connects a respective pair of nodes. A “sub-graph” of the synaptic connectivity graph can refer to a graph specified by: (i) a proper subset of the nodes of the synaptic connectivity graph, and (ii) a proper subset of the edges of the synaptic connectivity graph.

A “community sub-graph” of the synaptic connectivity graph can refer to a sub-graph that represents a community of neuronal elements in the brain of the biological organism. A “community” of neuronal elements can refer to a group of neuronal elements in the brain that tends to include a larger number of biological connections (e.g., synapses, nerve tracts, or any other appropriate biological connections) between neuronal elements within the group, relative to the number of biological connections between neuronal elements in different groups.

For convenience, throughout this specification, a neural network having an architecture specified by a sub-graph (or a community sub-graph) of the synaptic connectivity graph can be referred to as a “brain emulation” neural network. Identifying an artificial neural network as a “brain emulation” neural network is intended only to conveniently distinguish such neural networks from other neural networks (e.g., with hand-engineered architectures), and should not be interpreted as limiting the nature of the operations that may be performed by the neural network or otherwise implicitly characterizing the neural network.

According to a first aspect, there is provided a method performed by one or more data processing apparatus, the method including: obtaining data defining a connectivity graph that represents synaptic connectivity between multiple biological neuronal elements in a brain of a biological organism, where the connectivity graph includes: (i) multiple nodes, and (ii) multiple edges that each connect a respective pair of nodes, determining a partition of the connectivity graph into multiple community sub-graphs by performing an optimization that encourages a higher measure of connectedness between nodes included within each community sub-graph relative to nodes included in different community sub-graphs, and selecting a neural network architecture for performing a machine learning task using multiple community sub-graphs determined by the optimization that encourages the higher measure of connectedness between nodes included within each community sub-graph relative to nodes included in different community sub-graphs

Selecting the neural network architecture for performing the machine learning task using multiple community sub-graphs determined by the optimization includes: instantiating multiple candidate neural network architectures, where each candidate neural network architecture includes one or more brain emulation sub-networks that each have a respective architecture specified by a respective community sub-graph of multiple community sub-graphs, determining a respective performance measure of each of multiple candidate neural network architectures on the machine learning task, and selecting the neural network architecture for performing the machine learning task based on the performance measures of multiple candidate neural network architectures.

In some implementations, each of the community sub-graphs is predicted to represent a corresponding community of biological neuronal elements in the brain of the biological organism.

In some implementations, the method further includes, for each of multiple community sub-graphs: determining a respective set of features characterizing the community sub-graph, including a feature that predicts a biological function of the corresponding community of biological neuronal elements in the brain of the biological organism.

In some implementations, instantiating multiple candidate neural network architectures includes, for each of multiple candidate neural network architectures: selecting one or more community sub-graphs for inclusion in the candidate neural network architecture, and instantiating the candidate neural network architecture to include a respective brain emulation sub-network corresponding to each of the community sub-graphs selected for inclusion in the candidate neural network architecture.

In some implementations, for one or more of multiple candidate neural network architectures, selecting one or more community sub-graphs for inclusion in the candidate neural network architecture includes: selecting one or more community sub-graphs for inclusion in the candidate neural network architecture based at least in part on the respective set of features characterizing each of multiple community sub-graphs.

In some implementations, each node in the connectivity graph corresponds to a respective biological neuronal element in the brain of the biological organism, and each edge connecting a pair of nodes in the connectivity graph represents synaptic connectivity between a pair of biological neuronal elements in the brain of the biological organism.

In some implementations, the biological neuronal element in the brain of the biological organism is a biological neuron, a part of a biological neuron, or a group of biological neurons.

In some implementations, determining a partition of the connectivity graph into multiple community sub-graphs by performing an optimization that encourages a higher measure of connectedness between nodes included within each community sub-graph relative to nodes included in different community sub-graphs includes: determining a betweenness score for each of multiple edges in the connectivity graph, where the betweenness score for an edge characterizes a likelihood that the edge connects a pair of nodes included in different community sub-graphs of the connectivity graph, iteratively performing operations until a termination criterion is satisfied, the operations including: removing one or more edges from the connectivity graph that have the betweenness score above a threshold, removing one or more nodes from the connectivity graph that are not connected to any other nodes in the connectivity graph by an edge, determining a new betweenness score for each of the multiple remaining edges in the connectivity graph, and determining if the termination criterion is satisfied, and after determining that the termination criterion is satisfied, determining a partition of the connectivity graph into multiple community sub-graphs.

In some implementations, the betweenness score for the edge is a number of shortest paths between any two nodes in the connectivity graph that include the edge.

In some implementations, determining a partition of the connectivity graph into multiple community sub-graphs by performing an optimization that encourages a higher measure of connectedness between nodes included within each community sub-graph relative to nodes included in different community sub-graphs includes: iteratively performing operations until a termination criterion is satisfied, the operations including: selecting a first node in the connectivity graph, determining multiple candidate connectivity graphs based on the first node, determining a change in a modularity score for each of the candidate connectivity graphs, based on the change in the modularity score, selecting a candidate connectivity graph from multiple candidate connectivity graphs as a new connectivity graph, and determining if a termination criterion is satisfied, and after determining that the termination criterion is satisfied, determining the partition of the connectivity graph into multiple community sub-graphs.

In some implementations, the modularity score for a connectivity graph characterizes a connectivity between pairs of nodes in the graph relative to a connectivity between pairs of nodes in a randomly-connected graph.

In some implementations, determining multiple candidate connectivity graphs based on the first node includes iteratively performing operations until a termination criterion is satisfied, the operations including: identifying a second node in the connectivity graph, where the first node and the second node are connected by an edge, removing the edge that connects the first node to the second node and connecting all edges that connect the first node to the other nodes in the connectivity graph to the second node, generating the connectivity graph for the iteration, and determining if the termination criterion is satisfied, and after determining that the termination criterion is satisfied, determining multiple candidate connectivity graphs.

In some implementations, for each of multiple candidate neural network architectures, each brain emulation sub-network included in the candidate neural network architecture includes multiple brain emulation parameters that represent synaptic connectivity between multiple biological neuronal elements represented by the respective community sub-graph that specifies the architecture of the brain emulation sub-network.

In some implementations, multiple brain emulation parameters define a two-dimensional weight matrix having multiple rows and multiple columns, where each row and each column of the weight matrix corresponds to a respective biological neuronal element from multiple biological neuronal elements, and where each brain emulation parameter in the weight matrix corresponds to a respective pair of biological neuronal elements in the brain of the biological organism, the pair including: (i) the biological neuronal element corresponding to a row of the brain emulation parameter in the weight matrix, and (ii) the biological neuronal element corresponding to a column of the brain emulation parameter in the weight matrix.

In some implementations, each brain emulation parameter of the weight matrix has a respective value that characterizes synaptic connectivity in the brain of the biological organism between the respective pair of biological neuronal elements corresponding to the brain emulation parameter.

In some implementations, each brain emulation parameter of the weight matrix that corresponds to a respective pair of biological neuronal elements that are not connected by a synaptic connection in the brain of the biological organism has value zero.

In some implementations, each brain emulation parameter of the weight matrix that corresponds to a respective pair of biological neuronal elements that are connected by a synaptic connection in the brain of the biological organism has a respective non-zero value characterizing an estimated strength of the synaptic connection.

In some implementations, each brain emulation parameter of the weight matrix that corresponds to a respective pair of biological neuronal elements that are connected by a synaptic connection in the brain of the biological organism has a respective non-zero value that is based on a proximity of the pair of biological neuronal elements in the brain.

According to a second aspect, there is provided a system including: one or more computers, and one or more storage devices communicatively coupled to the one or more computers, where the one or more storage devices store instructions that, when executed by the one or more computers, cause the one or more computers to perform the operations of the method of any preceding aspect.

According to a third aspect, there are provided one or more non-transitory computer storage media storing instructions that when executed by one or more computers cause the one or more computers to perform the operations of the method of any preceding aspect.

Particular embodiments of the subject matter described in this specification can be implemented so as to realize one or more of the following advantages.

The method described in this specification can select a neural network architecture (e.g., a brain emulation neural network architecture) for performing a machine learning task in a biologically-intelligent manner. The method can obtain a synaptic connectivity graph, representing connections between neuronal elements in the brain of the biological organism, and determine a partition of the graph into multiple community sub-graphs. Each community sub-graph can represent a community of biological neuronal elements in the brain that may be functionally-specialized.

The method can select the architecture of a brain emulation neural network based on communities of biological neuronal elements in the brain, e.g., based on one or more community sub-graphs. Because the brains of biological organisms may be adapted by evolutionary pressures to be effective at solving certain tasks, e.g., classifying objects or generating robust object representations, a brain emulation neural network having an architecture that is specified by the synaptic connectivity graph (or one or more community sub-graphs of the synaptic connectivity graph), may share this capacity to effectively solve tasks.

Other techniques for selecting the architecture of the brain emulation neural network can include, e.g., identifying a region in the brain having a predefined shape, e.g., a cubical shape, and selecting the neuronal elements that are included in that region. However, because the neuronal elements are not generally organized according to such predefined geometrical regions in the brain, this leads to the selection of a collection of neuronal elements that are organized in an unnatural way.

In contrast, the method described in this specification can identify natural biological communities of neuronal elements in the brain, and specify the architecture of the brain emulation neural network on that basis. Therefore, a neural network that includes a brain emulation sub-network (e.g., a sub-network having an architecture that is specified by one or more community sub-graphs representing communities of biological neuronal elements in the brain) can require less training data, fewer training iterations, and/or less computational resources, to effectively solve certain tasks, when compared to neural networks specified by a collection of neuronal elements selected from an unnatural geometrical region in the brain.

Furthermore, the neural network architectures specified by a collection of neuronal elements selected from an unnatural geometrical region in the brain can include a variety of different elements which may or may not be relevant to solving a particular machine learning task. In other words, such architectures can include “noise” that can degrade the performance of the neural network on the task.

By contrast, specifying the brain emulation neural network architecture based on natural community structure in the brain, represented by the community sub-graphs, can ensure that the majority of elements that are relevant to solving a particular task are included in the architecture, while minimizing elements in the architecture that are not relevant to solving the task. This can increase the effectiveness of the brain emulation neural network at performing the task, when compared to neural networks specified by the collection of neuronal elements selected from an unnatural geometrical region in the brain.

Moreover, specifying the architecture based on a community sub-graph can result in the architecture having a reduced complexity, e.g., because the community sub-graph can be less complex than a sub-graph of the synaptic connectivity graph that represents neuronal elements in a predefined geometrical region in the brain. Reducing the complexity of the architecture can reduce consumption of computational resources (e.g., memory and computing power) by the brain emulation neural network, e.g., enabling the brain emulation neural network to be deployed in resource-constrained environments, e.g., mobile devices.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example data flow for selecting a neural network architecture for performing a machine learning task based on community sub-graphs of a synaptic connectivity graph.

FIG. 2 is a block diagram of an example optimization system that selects a neural network architecture for performing a machine learning task based on community sub-graphs of a synaptic connectivity graph.

FIG. 3 illustrates example community sub-graphs of a synaptic connectivity graph.

FIG. 4 is a flow diagram of an example process for selecting a neural network architecture for performing a machine learning task based on community sub-graphs of a synaptic connectivity graph.

FIG. 5 is a block diagram of an example computing system that includes a neural network architecture selected for performing a machine learning task based on community sub-graphs of a synaptic connectivity graph.

FIG. 6 illustrates an example weight matrix determined using a community sub-graph of the synaptic connectivity graph.

FIG. 7 illustrates an example data flow for generating a synaptic connectivity graph based on the brain of a biological organism.

FIG. 8 is a block diagram of an example architecture mapping system.

FIG. 9 is a block diagram of an example computer system.

Like reference numbers and designations in the various drawings indicate like elements.

### DETAILED DESCRIPTION

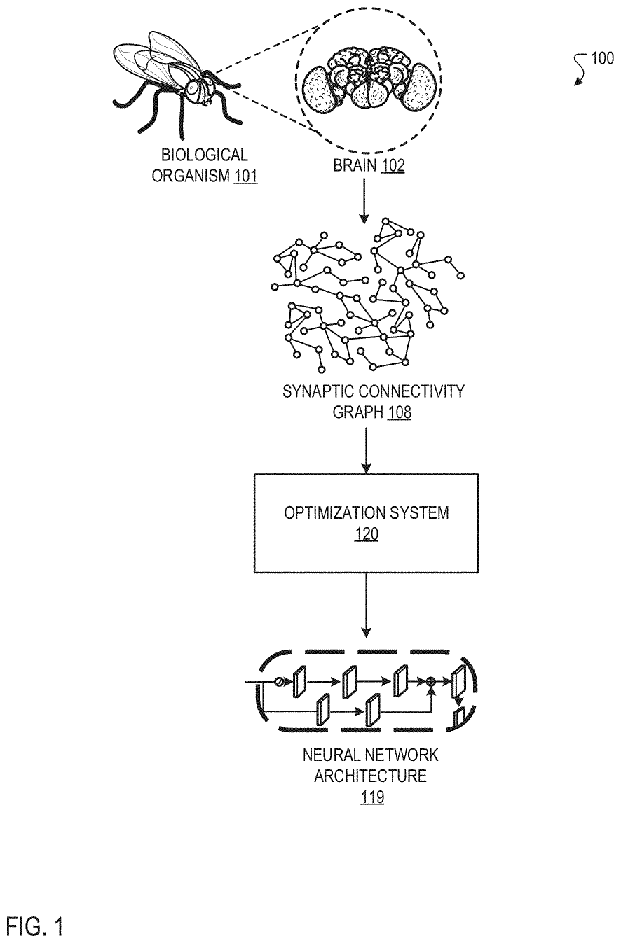

FIG. 1 illustrates an example data flow 100 for selecting a neural network architecture 119 for performing a machine learning task based on community sub-graphs of a synaptic connectivity graph 108.

As used throughout this document, a brain 102 can refer to any amount of nervous tissue from a nervous system of the biological organism 101, and nervous tissue can refer to any tissue that includes neurons (i.e., nerve cells). The biological organism 101 can be, e.g., a fly, a worm, a cat, a mouse, or a human.

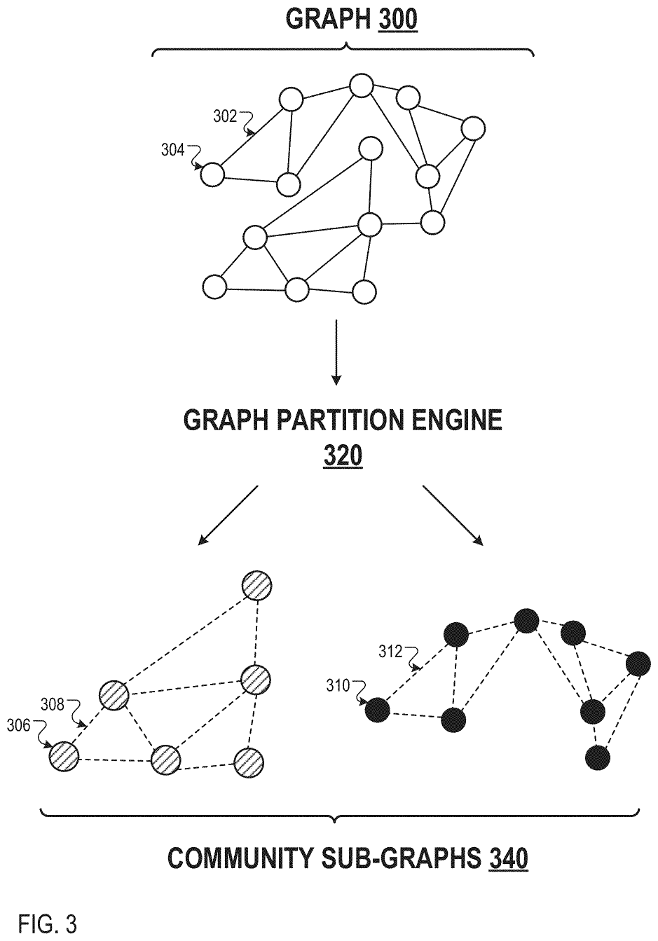

The synaptic connectivity graph 108 represents synaptic connectivity between neuronal elements in the brain 102 of the biological organism 101. A “neuronal element” can refer to an individual neuron, a portion of a neuron, a group of neurons, or any other appropriate biological element in the brain 102 of the biological organism 101. As will be described in more detail below with reference to FIG. 3, the synaptic connectivity graph 108 can include multiple nodes and multiple edges, where each edge connects a respective pair of nodes. In one example, each node in the graph 108 can represent an individual neuron, and each edge connecting a pair of nodes in the graph 108 can represent a respective synaptic connection between the corresponding pair of individual neurons.

In some implementations, the synaptic connectivity graph 108 can be an “over-segmented” synaptic connectivity graph, e.g., where at least some nodes in the graph represent a portion of a neuron, and at least some edges in the graph connect pairs of nodes that represent respective portions of neurons.

In some implementations, the synaptic connectivity graph 108 can be a “contracted” synaptic connectivity graph, e.g., where at least some nodes in the graph represent a group of neurons, and at least some edges in the graph represent respective connections (e.g., nerve fibers) between such groups of neurons.

In some implementations, the synaptic connectivity graph 108 can include features of both the “over-segmented” graph and the “contracted” graph. Generally, the synaptic connectivity graph 108 can include nodes and edges that represent any appropriate neuronal element, and any appropriate biological connection between a pair of neuronal elements, respectively, in the brain 102 of the biological organism 101.

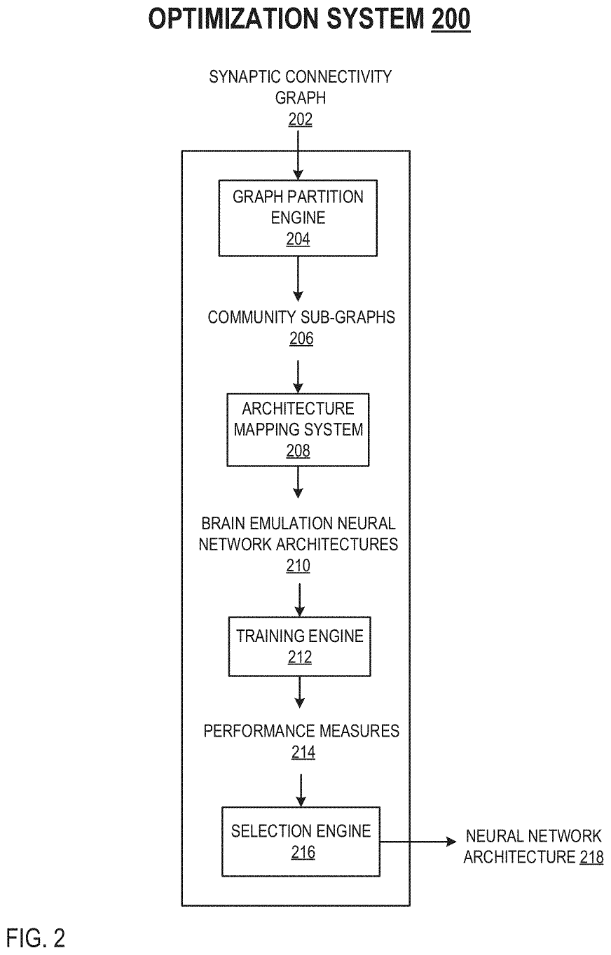

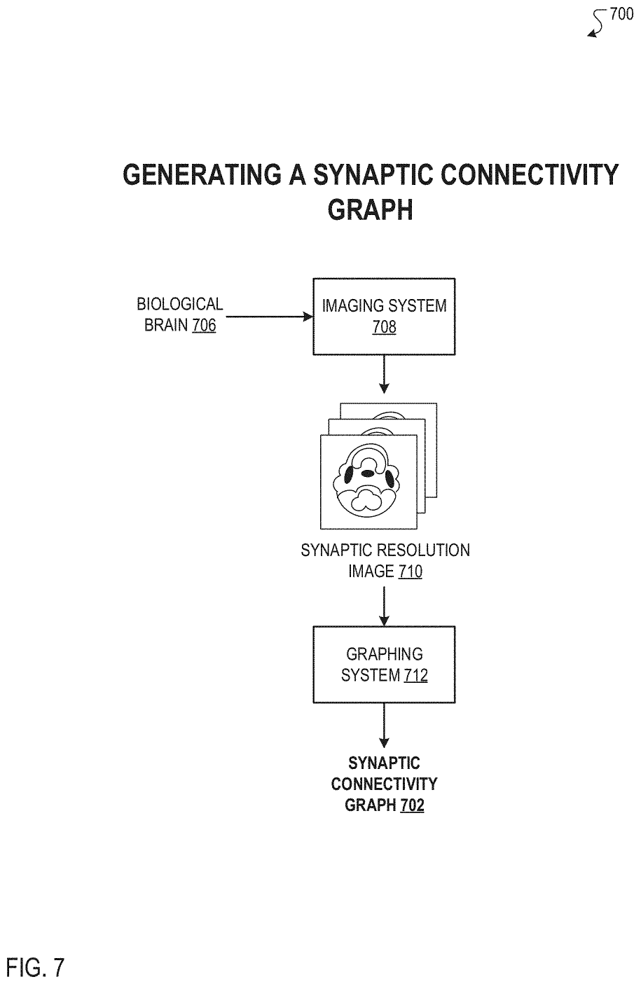

As will be described in more detail below with reference to FIG. 7, an imaging system can obtain an image of the brain 102 of the biological organism 101, and a graphing system can process the image of the brain 102 to generate the synaptic connectivity graph 108. An optimization system 120 can process the graph 108 and partition the graph 108 into multiple community sub-graphs. Based on the community sub-graphs, the system 120 can select the neural network architecture 119 for performing the machine learning task. This process will be described in more detail below with reference to FIG. 2.

Generally, the brain 102 of the biological organism 101 can include ensembles (groups) of biological neuronal elements that have a substantially large number of biological connections (e.g., synapses, or nerve tracts) between neuronal elements within the ensemble, relative to the number of biological connections between neuronal elements in different ensembles. In other words, neuronal elements within the ensemble can be more densely connected (e.g., clustered) when compared to neuronal elements in different ensembles. Such ensembles can be referred to as “communities” of biological neuronal elements. Some communities of biological neuronal elements in the brain 102 can be functionally-specialized, e.g., can perform a particular function such as processing of visual data, processing of audio data, or any other appropriate function.

For example, biological neuronal elements within the visual cortex region of the brain 102 can be densely connected to facilitate efficient processing of visual information, while biological neuronal elements within the auditory data processing region of the brain 102 can be densely connected to facilitate efficient processing of auditory information. However, connections between neuronal elements that are positioned in the visual cortex and neuronal elements that are positioned in the audio cortex can be relatively sparse. Accordingly, biological neuronal elements within each of these regions of the brain 102 can each belong to a different functionally-specialized community.

However, the above example is provided for illustrative purposes only, and each community of biological neuronal elements in the brain 102 may not necessarily be functionally-specialized, and some communities of biological neuronal elements can perform the same, or similar, function, as some of the other communities of biological neuronal elements in the brain 102.

The optimization system 120 can process the synaptic connectivity graph 108 and determine a partition of the graph 108 into multiple community sub-graphs. Generally, a “sub-graph” of the synaptic connectivity graph 108 can refer to a graph specified by: (i) a proper subset of the nodes of the synaptic connectivity graph 108, and (ii) a proper subset of the edges of the synaptic connectivity graph 108. A “community sub-graph” of the synaptic connectivity graph 108 can refer to a sub-graph that represents biological neuronal elements that belong to a community in the brain 102 of the biological organism 101. Example community sub-graphs will be described in more detail below with reference to FIG. 3.

The optimization system 120 can partition the synaptic connectivity graph 108 into multiple community sub-graphs by performing an optimization that encourages a higher measure of connectedness between nodes included within each community sub-graph, relative to nodes included in different community sub-graphs. By partitioning the synaptic connectivity graph 108 in this manner, the optimization can therefore encourage the identification of individual communities of biological neuronal elements in the brain, where each community is represented by a respective community sub-graph of the synaptic connectivity graph 108.

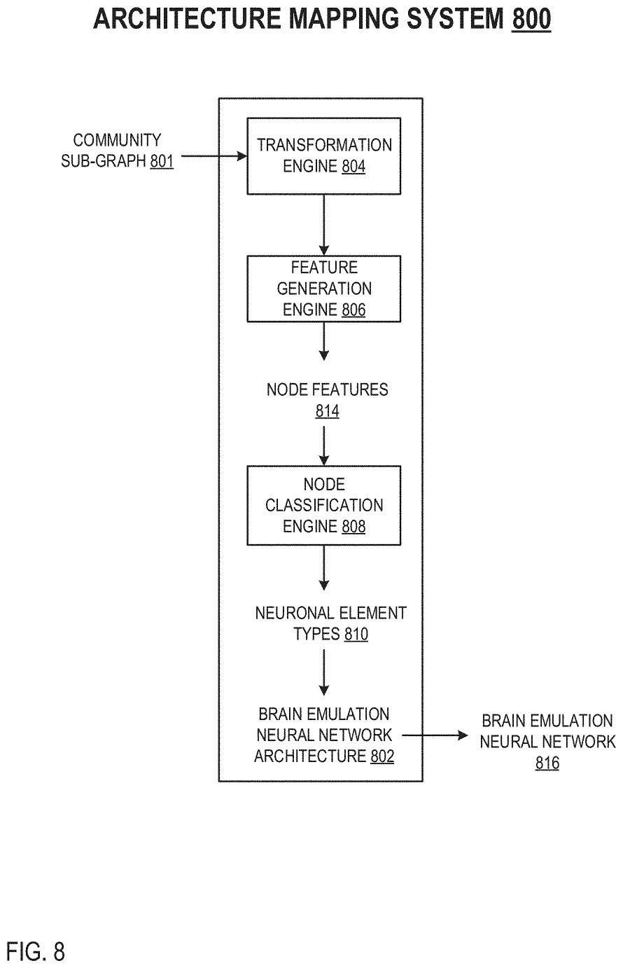

In some implementations, for each community sub-graph, the optimization system 120 can determine a set of features that predict a biological function of the corresponding community of biological neuronal elements in the brain 102 of the biological organism 101. For example, as will be described in more detail below with reference to FIG. 8, an architecture mapping system can process each community sub-graph and determine types of neuronal elements that are represented by the nodes included in each of the community sub-graphs. Based on the predicted neuronal element types, the architecture mapping system can associate each community sub-graph with one or more corresponding functions in the brain 102 of the biological organism 101.

The optimization system 120 can select the neural network architecture 119 for performing the machine learning task based on community sub-graphs. For example, as will be described in more detail below with reference to FIGS. 2 and 8, the optimization system 120 can instantiate multiple candidate neural network architectures, each architecture including one or more brain emulation sub-networks that each have a respective architecture specified by a respective community sub-graph. The optimization system 120 can evaluate a performance of each candidate neural network architecture at the machine learning task.

By way of example, the optimization system 120 can process the synaptic connectivity graph 108 and identify a community sub-graph that represents a community of biological neuronal elements in the visual cortex, and a community sub-graph that represents a community of biological neuronal elements in the auditory cortex. The system 120 can instantiate candidate neural network architectures based on each of these community sub-graphs, and evaluate their performance at the machine learning task, e.g., a visual processing task. Because different regions of the brain 102 of the biological organism 101 may be adapted by evolutionary pressures to be effective at solving certain tasks, or performing certain functions, the candidate neural network architectures, based on the respective community sub-graphs that represent different regions of the brain 102, may inherit the capacity of the respective regions of the brain to effectively solve tasks.

Accordingly, in this example, the system 120 can determine, e.g., that the candidate neural network architecture that is specified by the community sub-graph that represents biological neuronal elements in the visual cortex region of the brain 102 is more effective at performing the visual processing task, than the candidate neural network architecture that is specified by the community sub-graph that represents the auditory cortex region of the brain 102. The system 120 can select, e.g., the most effective candidate neural network architecture 119 for performing the machine learning task, e.g., the visual processing task in this example.

After selecting the neural network architecture 119, the system 120 can instantiate a neural network having the neural network architecture 119 and use it to perform the machine learning task. However, the above example is provided for illustrative purposes only, and in some cases the system 102 may not necessarily select the best-performing candidate neural network architecture. Further, the system 120 can select any number of neural network architectures 119 for performing any appropriate number and type of machine learning tasks.

An example optimization system will be described in more detail next.

FIG. 2 is a block diagram of an example optimization system 200 that selects a neural network architecture 218 for performing a machine learning task (e.g., the neural network architecture 119 in FIG. 1) based on community sub-graphs (e.g., the sub-graphs 340 in FIG. 3) of a synaptic connectivity graph 202 (e.g., the graph 108 in FIG. 1, or the graph 300 in FIG. 3). The system 200 is an example of a system implemented as computer programs on one or more computers in one or more locations in which the systems, components, and techniques described below are implemented.

As described above with reference to FIG. 1, the synaptic connectivity graph 202 can represent synaptic connectivity between neuronal elements in the brain of a biological organism. The graph 202 can be obtained from a synaptic resolution image of the brain, e.g., as described in more detail below with reference to FIG. 7. The system 200 can process data defining the synaptic connectivity graph 202 and determine a partition of the graph 202 into multiple community sub-graphs, where each sub-graph can represent a respective community of biological neuronal elements in the brain of a biological organism. Based on the community sub-graphs, the system 200 can select the neural network architecture 218 for performing the machine learning task.

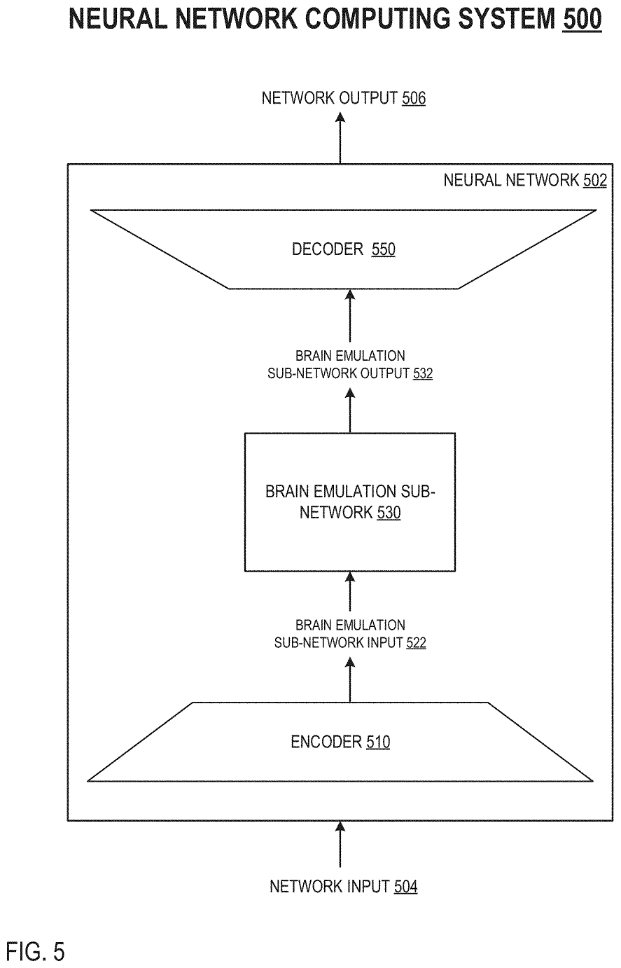

After selecting the neural network architecture 218 for performing the machine learning task, the system 200 can instantiate a corresponding neural network (e.g., as described below with reference to FIG. 5) and uses it to perform the task.

The optimization system 200 can include: (i) a graph partition engine 204, (ii) an architecture mapping system 208, (iii) a training engine 212, and (iv) a selection engine 216, each of which will be described in more detail next.

The graph partition engine 204 can process data defining the synaptic connectivity graph 202 and determine a partition of the graph 202 into multiple community sub-graphs 206. Each community sub-graph can include a proper subset of the nodes and edges of the synaptic connectivity graph 202. To partition the graph 202, the engine 204 can perform an optimization that encourages a higher measure of connectedness between nodes included in each community sub-graph relative to nodes included in different community sub-graphs. The graph partition engine 204 can perform the optimization using any of a variety of techniques. A few examples follow.

In one example, the graph partition engine 204 can partition the synaptic connectivity graph 202 into multiple community sub-graphs 206 based on a betweenness score determined for each edge in the graph 202. Generally, a “betweenness score” for an edge in a graph can characterize a likelihood that the edge connects a pair of nodes included in different community sub-graphs of the connectivity graph. As a particular example, the betweenness score can represent the fraction of shortest paths in the graph that include the edge. A path in the graph can refer to a sequence of nodes in the graph, such that each node in the path is connected by an edge to the next node in the path. The length of a path in the graph can refer to the number of nodes in the path.

The shortest path between any pair of nodes in the graph can refer to the smallest number of sequential nodes (e.g., where each node is connected to the next node by an edge) that are traversed from one node in the pair of nodes to the other node in the pair of nodes. As another particular example, the betweenness score for an edge can represent the number of shortest paths between any pair of nodes in the graph, where each of the paths includes the edge. A higher betweenness score for an edge can generally indicate that the edge has a higher probability of connecting two different communities, compared to the other edges in the graph, e.g., the edges that have a lower betweenness score. In other words, a higher betweenness score for an edge can indicate that the edge is positioned “in-between” communities in the graph, compared to the other edges in the graph.

The graph partition engine 204 can determine the betweenness score for each edge in the connectivity graph 202. After initially determining the scores for all edges in the graph 202, the engine 204 can iteratively remove one or more edges from the graph 202 based on the betweenness score until a termination criterion is satisfied.

At each iteration, the engine 204 can determine which edges to remove from the connectivity graph 202 based on the betweenness scores. For example, the engine 204 can determine which edges have the betweenness score above a particular threshold and remove these edges from the connectivity graph 202. In some implementations, the engine 204 can determine which edges in the connectivity graph 202 have the highest betweenness score (e.g., which edges are the most “between” communities in the graph 202) and remove these edges from the connectivity graph 202.

After removing one or more edges from the connectivity graph 202, at each iteration, the engine 204 can determine if there are any nodes in the graph 202 that are no longer connected to any other nodes in the graph 202 by an edge. If any such nodes exist, the engine 204 can remove these nodes from the connectivity graph 202.

Next, at each iteration, the engine 204 can determine a new betweenness score for each of multiple remaining edges in the connectivity graph 202. In particular, the betweenness score for one or more of the remaining edges in the connectivity graph 202 can change because of the removal of one or more edges at the previous step. After determining new betweenness scores, the engine 204 can determine if the termination criterion is satisfied. The termination criterion can be any appropriate criterion. In one example, the process can terminate after a predetermined number of iterations. In another example, the process can terminate after the engine 204 determines that none of the remaining edges in the connectivity graph 202 have the betweenness score above the threshold. In some implementations, the threshold for the betweenness score can be different at each iteration.

After determining that the termination criterion is satisfied, the engine 204 can determine the partition of the connectivity graph 202 into multiple community sub-graphs 206. For example, the engine 204 can determine that some or all of the edges that are most “in-between” communities in the connectivity graph have been removed, and the remaining components (e.g., sub-graphs) of the connectivity graph each represent a respective community of biological neuronal elements in the brain of the biological organism.

In some implementations, the engine 204 can identify one or more of the remaining components (e.g., sub-graphs) of the connectivity graph 202 that are internally connected by edges, but are not connected by edges to any other components of the connectivity graph 202, e.g., no edges exist that connect a node in a sub-graph of the connectivity graph 202 to a node in any other sub-graph of the connectivity graph 202. The engine 204 can determine that each of such “connected” components is predicted to be a respective community sub-graph 206.

In some implementations, the engine 204 can identify one or more of the remaining components (e.g., sub-graphs) of the connectivity graph 202 that are connected by edges to one or more of the other components of the connectivity graph 202, but the number of edges that connects the components to each other is below a particular threshold, e.g., the number of edges that connects the nodes in a first sub-graph to the nodes in any other sub-graph is below the threshold. The engine 204 can remove the edges connecting such components and determine that each of such components is predicted to be a respective community sub-graph 206.

An example process for determining a partition of a graph into sub-graphs using betweenness scores is described with reference to: Girvan, Michelle, and Mark E J Newman, “Community structure in social and biological networks,” Proceedings of the National Academy of Sciences 99.12 (2002): 7821-7826, which is incorporated by reference herein in its entirety.

In another example, the graph partition engine 204 can partition the synaptic connectivity graph 202 into multiple community sub-graphs 206 based on a modularity score. Generally, a “modularity score” of a graph can quantify the “strength” of community structure in the graph by comparing the fraction of edges between pairs of nodes within communities in the graph with the fraction of edges between pairs of nodes in a randomly-connected graph (e.g., a graph that does not exhibit community structure). The modularity score Q for a graph that includes a set of communities C can be represented as:

$$Q = {\sum }_{C} [ \frac{\vert {E}_{{c}_{i}}^{in} \vert}{\vert E \vert} - {( \frac{2 \vert {E}_{{c}_{i}}^{in} \vert + \vert {E}_{{c}_{i}}^{out} \vert}{2 \vert E \vert} )}^{2} ] \qquad ( 1 )$$

where cᵢ is a specific community in the set C, |E_{c}_{ᵢ}ⁱⁿ| is the number of edges between pairs of nodes within the community cᵢ, |E_{c}_{ᵢ}^{out}| is the number of edges between the nodes that are in the community cᵢ and the nodes that are outside the community cᵢ, and |E| is the total number of edges in the graph. Generally, a larger value of the modularity score Q can indicate a stronger community structure in a graph (e.g., more edges between pairs of nodes in the same community in the graph, when compared to the number of edges connecting pairs of nodes in different communities in the graph).

The graph partition engine 204 can initially assign all nodes in the graph 202 as belonging to their own individual community cᵢ, such that the set of all communities C is equal to the total number of nodes in the graph 202. The engine 204 can iteratively generate candidate connectivity graphs by merging pairs of communities in the graph 202, and determine a change in the modularity score for each candidate connectivity graph that resulted from the merging operation. Generally, “merging” a first node and a second node, where the nodes are neighbors (e.g., the nodes are connected by an edge), refers to removing the edge that connects the first node and the second node, removing the first node, and connecting all edges that connect the first node and any other node in the graph to the second node.

At each iteration, the engine 204 can select a first node in the connectivity graph 202 and generate multiple candidate connectivity graphs based on the first node. The engine 204 can generate the candidate connectivity graphs by performing multiple internal iterations. Specifically, at each internal iteration, the engine 204 can identifying a second node in the connectivity graph 202, where the first node and the second node are connected by an edge, perform the merging operation by removing the edge that connects the first node to the second node and connecting all edges that connect the first node to the other nodes in the connectivity graph to the second node, and generating the connectivity graph for the internal iteration.

The internal iterations can terminate after a termination criterion is satisfied. The criterion can be, e.g., any appropriate criterion. For example, the internal iterations can terminate after all neighboring nodes of the first node have been selected at least once. After multiple internal iterations, the engine 204 can generate multiple respective candidate connectivity graphs.

After generating multiple candidate connectivity graphs, at each iteration, the engine 204 can determine a change in the modularity score that resulted from generating each respective candidate connectivity graph. The change in the modularity score ΔQ upon merging two communities cᵢ and cⱼ (e.g., upon performing the merging operation on a pair of neighboring nodes i and j in the connectivity graph 202) can be represented as:

$$Δ Q = 2 ( \frac{\vert {E}_{{c}_{i} {c}_{j}} \vert}{2 \vert E \vert} - \frac{\vert {E}_{{c}_{i}} \vert \vert {E}_{{c}_{j}} \vert}{4 {\vert E \vert}^{2}} ) \qquad ( 2 )$$

where |E_{c}_{ᵢ}_{c}_{ⱼ}| is the number of edges that connect nodes in the community cᵢ with nodes in the community cⱼ, and |E_{c}_{ᵢ}|=2|E_{c}_{ᵢ}ⁱⁿ|+|E_{c}_{ᵢ}^{out}| is the total degree of nodes in community cᵢ. A “degree” of a node refers to the number of other nodes that are connected to the given node by an edge.

At each iteration, based on the change in modularity score determined for each candidate connectivity graph according to Equation (2), the engine 204 can select one candidate connectivity graph from multiple candidate graphs that resulted in a desirable change in the modularity score. In one example, because a higher modularity score generally indicates stronger community structure in a graph, the engine 204 can select the candidate connectivity graph that resulted in the largest positive change ΔQ in the modularity score.

In another example, the engine 204 can select the candidate connectivity graph with the smallest negative change ΔQ in the modularity score. In yet another example, the engine 204 can select the candidate connectivity graph that did not result in any change in the modularity score (e.g., ΔQ=0). After selecting one candidate connectivity graph, the engine 204 can designate this graph as the new connectivity graph, and proceed to the next iteration.

At each iteration, the engine 204 can determine if a termination criterion is satisfied. The criterion can be, e.g., any appropriate criterion. In one example, the engine 204 can terminate the process when only two nodes (e.g., only two communities cᵢ and cⱼ) are remaining in the connectivity graph 202.

After determining that the termination criterion is satisfied, the engine 204 can determine the partition of the connectivity graph 202 into multiple community sub-graphs 206. In one example, the engine 204 can determine the modularity score Q according to Equation (1) for all connectivity graphs generated over the plurality of iterations and select the connectivity graph with the highest modularity score. The engine 204 can, e.g., remove all edges in the connectivity graph with the highest modularity score to generate the partition of the graph into multiple community sub-graphs.

An example process for determining a partition of a graph into sub-graphs using modularity scores is described with reference to: M. E. J. Newman and M. Girvan, “Finding and evaluating community structure in networks,” Phys. Rev. E, vol. 69, p. 026113, February 2004, which is incorporated by reference herein in its entirety.

The above examples are provided for illustrative purposes only, and the engine 204 can partition the connectivity graph 202 into multiple community sub-graphs 206 in any other appropriate manner. Example techniques for partitioning the graph 202 into community sub-graphs 206 can include: NetworkX described in more detail with reference to: Hagberg, Aric, Swart, Pieter, & S Chult, Daniel, “Exploring network structure, dynamics, and function using networkx,” United States; iGraph described in more detail with reference to: Csárdi, Gábor and Tamás Nepusz. “The igraph software package for complex network research,” (2006); PageRank described in more detail with reference to: Stergiou, Stergios, “Scaling PageRank to 100 billion pages,” In Proceedings of The Web Conference 2020, pp. 2761-2767. 2020, and affinity clustering described in more detail with reference to: Bateni, Mohammad Hossein, et al., “Affinity clustering: Hierarchical clustering at scale,” Proceedings of the 31st International Conference on Neural Information Processing Systems. 2017, each of which are entirely incorporated by reference herein.

As described in more detail with reference to FIG. 8, the architecture mapping system 208 can process each community sub-graph 206 to generate a corresponding brain emulation neural network architecture 210. For example, the architecture mapping system 208 can map each node in the community sub-graph 206 to a corresponding: (i) artificial neuron, (ii) artificial neural network layer, or (iii) group of artificial neural network layers in the architecture 210. Further, the system 208 can map each edge in the community sub-graph 206 to a corresponding connection in the architecture 210.

In some implementations, for each community sub-graph 206, the architecture mapping system 208 can determine a respective set of one or more features that predict a biological function of the corresponding community of biological neuronal elements in the brain of the biological organism e.g., a visual function by processing visual data, an olfactory function by processing odor data, or a memory function by retaining information. After identifying the types of neuronal elements corresponding to the nodes in the community sub-graphs 206, the architecture mapping system 208 can select one or more community sub-graphs 206 based on the types of neuronal elements and/or based on their predicted functions and instantiate corresponding brain emulation neural network architecture(s) 210.

For each brain emulation neural network architecture 210, the training engine 212 can instantiate a candidate neural network, e.g., the neural network 502 described below with reference to FIG. 5. The candidate neural network can include: (i) one or more brain emulation sub-networks, each of which can be specified by a respective community sub-graph, and (ii) one or more other neural network layers, e.g., fully-connected layers, convolutional layers, attention layers, or any other appropriate layers.

Generally, the training engine 212 can instantiate multiple candidate neural networks having any appropriate configuration. In one example, the training engine 212 can instantiate a candidate neural network having multiple copies of the same brain emulation neural network architecture. In another example, the training engine 212 can instantiate a candidate neural network having multiple different brain emulation neural network architectures 210, e.g., each brain emulation neural network architecture being specified by a different community sub-graph. The training engine 212 can instantiate any appropriate number and configuration of the candidate neural networks, including any appropriate number and configuration of brain emulation neural network architectures 210, and evaluate each candidate neural network at the same machine learning task, as will be described in more detail next.

Each candidate neural network is configured to perform the machine learning task, e.g., by processing a network input to generate a corresponding network output that defines a prediction characterizing the network input. The machine learning task can be any appropriate machine learning task, e.g., a classification task, a regression task, a segmentation task, an agent control task, or a combination thereof. The training engine 212 is configured to train each candidate neural network over multiple training iterations.

The training engine 212 determines a respective performance measure 214 of each candidate neural network on the machine learning task. For example, the training engine 214 can train each candidate neural network on a set of training data over a sequence of training iterations, e.g., as described with reference to FIG. 5. The training engine 214 can then evaluate the performance of each candidate neural network on a set of validation data, e.g., that includes a set of training examples that are part of the training data used to train the candidate neural network. The training engine 214 can evaluate the performance of each candidate neural network based on the set of validation data, e.g., by computing an average error (e.g., cross-entropy error or squared-error) in network outputs generated by each candidate neural network for the validation data.

The selection engine 216 can select the neural network architecture 218 for performing the machine learning task based on the performance measures 214 of the candidate neural networks. In one example, the selection engine 216 can select the candidate neural network that has the best (e.g., the highest) performance measure 214. The selection engine 216 can provide the architecture of the candidate neural network as the output that represents the neural network architecture 218 suitable for performing the machine learning task.

Because the optimization system 200 selects the neural network architecture 218 in a biologically-informed manner, e.g., on the basis of community structure of biological neuronal elements in the brain, it can increase the parity between the topological structure of the neural network architecture 218 and the corresponding topological structure of nervous tissue in a region of the brain. In other words, the optimization system 200 can include structural elements in the architecture 218 that are biologically-relevant to solving a particular task, while minimizing aspects of the architecture that are not biologically-relevant to solving the task. Therefore, the neural network architecture 218 can more effectively inherit the capacity of nervous tissue in a region of the brain to perform a particular task which can, in turn, increase the effectiveness of the computing system at performing the machine learning task.

FIG. 3 illustrates example community sub-graphs 340 of a synaptic connectivity graph 300 generated by a graph partition engine 320 (e.g., the graph partition engine 204 in FIG. 2). The synaptic connectivity graph 300 can be, e.g., the graph 108 in FIG. 1, the graph 202 in FIG. 2, the graph 702 in FIG. 7, or the graph 801 in FIG. 8.

Each node in the graph 300 is represented by a circle 304 and each edge in the graph 300 is represented by a line 302. In this illustration, the graph 300 can be considered a simplified representation of a synaptic connectivity graph (an actual synaptic connectivity graph can have far more nodes and edges than are depicted in FIG. 3).

As described above with reference to FIG. 2, the graph partition engine 320 can process data defining the synaptic connectivity graph 300 and determine a partition of the graph 300 into multiple community sub-graphs 340. For example, as illustrated in FIG. 3, the nodes included in the first community sub-graph are represented by hatched circles 306, and the edges included in the first community sub-graph are represented by dashed lines 308. The nodes included in the second community sub-graph are represented by filled circles 310 and the edges included in the second community sub-graph are represented by dashed lines 312. Generally, each community sub-graph 304 can include a proper subset of the nodes and edges of the graph 300.

The optimization can encourage a higher measure of connectedness between nodes included within each community sub-graph relative to nodes included in different community sub-graphs. For example, as described above with reference to FIG. 2, the graph partition engine 320 can identify the edges in the graph 300 that have a betweenness score above a threshold (e.g., that are the most “between” different communities in the graph 300) and remove these edges to partition the graph 300 into multiple community sub-graphs 340.

In another example, as described above with reference to FIG. 2, the engine 320 can identity a candidate connectivity graph with the largest modularity score calculated according to Equation (1), and partition the graph 300 into multiple community sub-graphs 340 based on the candidate connectivity graph by, e.g., removing all edges in the candidate connectivity graph. Each community sub-graph 340 can accordingly represent connectivity of biological neuronal elements that belong to a community in the brain of the biological organism.

An example process for selecting a neural network architecture for performing a machine learning task based on community sub-graphs of a synaptic connectivity graph will be described in more detail next.

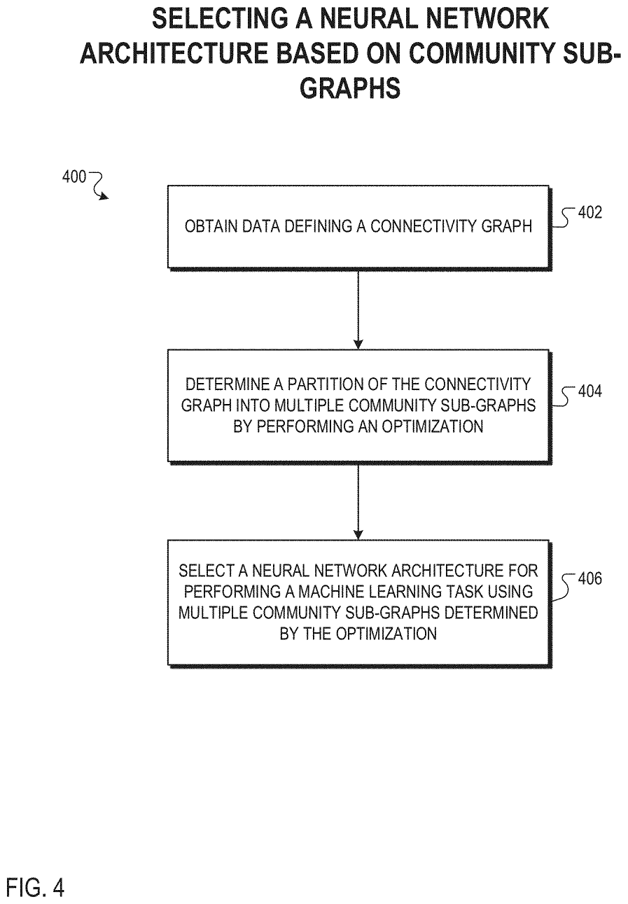

FIG. 4 is a flow diagram of an example process 400 for selecting a neural network architecture (e.g., the neural network architecture 119 in FIG. 1) for performing a machine learning task based on community sub-graphs of a synaptic connectivity graph (e.g., the synaptic connectivity graph 108 in FIG. 1). For convenience, the process 400 will be described as being performed by a system of one or more computers located in one or more locations. The system can be, e.g., the optimization system 120 in FIG. 1, or the optimization system 200 in FIG. 2.

The system obtains data defining a connectivity graph that represents synaptic connectivity between multiple biological neuronal elements in a brain of a biological organism (402). The graph can include multiple nodes and multiple edges, where each edge connects a respective pair of nodes. Each node in the connectivity graph can correspond to a respective biological neuronal element in the brain of the biological organism, and each edge connecting a pair of nodes in the connectivity graph can represent synaptic connectivity between a pair of biological neuronal elements in the brain of the biological organism. Each biological neuronal element in the brain of the biological organism can be a biological neuron, a portion of a biological neuron, or a group of biological neurons.

The system determines a partition of the connectivity graph into multiple community sub-graphs by performing an optimization that encourages a higher measure of connectedness between nodes included within each community sub-graph relative to nodes included in different community sub-graphs (404). Each of the community sub-graphs can be predicted to represent a corresponding community of biological neuronal elements in the brain of the biological organism.

In some implementations, the system can determine the partition of the connectivity graph into multiple community sub-graphs by determining a betweenness score for each of multiple edges in the connectivity graph. The betweenness score for an edge can represent a fraction of shortest paths in the connectivity graph that include the edge, e.g., the number of shortest paths between any two nodes in the connectivity graph that include the edge. The system can iteratively perform operations until a termination criterion is satisfied.

The operations can include removing one or more edges from the connectivity graph that have the betweenness score above a threshold, removing one or more nodes from the connectivity graph that are not connected to any other nodes in the connectivity graph by an edge, determining a new betweenness score for each of the remaining edges in the connectivity graph, and determining if the termination criterion is satisfied. After determining that the termination criterion is satisfied, the system can determine the partition of the connectivity graph into multiple community sub-graphs. The betweenness score for an edge can characterize a minimum path between any two nodes in the connectivity graph, where the minimum path includes the edge.

In some implementations, the system can determine the partition of the connectivity graph into multiple community sub-graphs based on a modularity score. The system can iteratively perform operations until a termination criterion is satisfied.

The operations can include selecting a first node in the connectivity graph, determining multiple candidate connectivity graphs based on the first node, determining a change in a modularity score for each of the candidate connectivity graphs, based on the change in the modularity score selecting a candidate connectivity graph from multiple candidate connectivity graphs as a new connectivity graph, and determining if a termination criterion is satisfied. After determining that the termination criterion is satisfied, the system can determine the partition of the connectivity graph into the plurality of community sub-graphs.

The system can determine multiple candidate connectivity graphs by iteratively performing operations until a termination criterion is satisfied. The operations can include identifying a second node in the connectivity graph, where the first node and the second node are connected by an edge, removing the edge that connects the first node to the second node and connecting all edges that connect the first node to the other nodes in the connectivity graph to the second node, generating the connectivity graph for the iteration, and determining if the termination criterion is satisfied.

In some implementations, the modularity score for a connectivity graph can characterize a connectivity between pairs of nodes in the graph relative to a connectivity between pairs of nodes in a randomly-connected graph.

The system selects the neural network architecture for performing the machine learning task using multiple community sub-graphs determined by the optimization that encourages the higher measure of connectedness between nodes included within each sub-graph relative to nodes included in different community sub-graphs (406).

As described in more detail above with reference to FIG. 2, the system can instantiate multiple candidate neural network architectures, where each candidate neural network architecture includes one or more brain emulation sub-networks that each have a respective architecture specified by a respective community sub-graph of multiple community sub-graphs. The system can determine a respective performance measure of each of multiple candidate neural network architectures on the machine learning task, and select the neural network architecture for performing the machine learning task based on the performance measures.

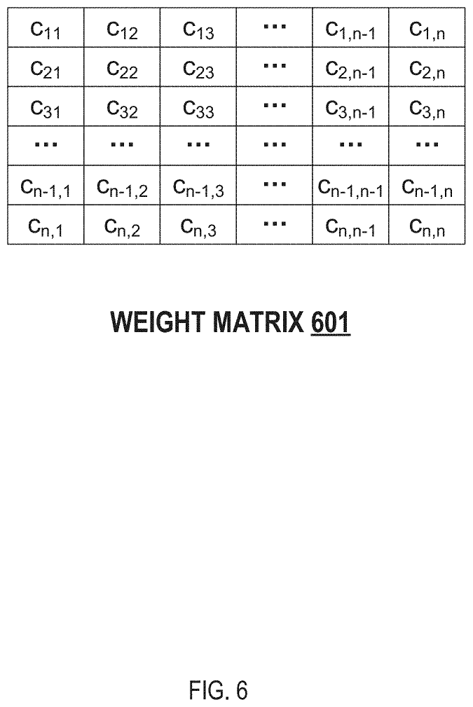

In some implementations, for each of multiple candidate neural network architectures, each brain emulation sub-network included in the candidate neural network architecture includes multiple brain emulation parameters (e.g., as described in more detail below with reference to FIG. 6) that represent synaptic connectivity between multiple biological neuronal elements represented by the respective community sub-graph that specifies the architecture of the brain emulation sub-network.

The brain emulation parameters can define a two-dimensional weight matrix having a multiple rows and multiple columns, where each row and each column of the weight matrix corresponds to a respective biological neuronal element, and each brain emulation parameter in the weight matrix corresponds to a respective pair of biological neuronal elements in the brain of the biological organism, the pair including: (i) the biological neuronal element corresponding to a row of the brain emulation parameter in the weight matrix, and (ii) the biological neuronal element corresponding to a column of the brain emulation parameter in the weight matrix.

Each brain emulation parameter of the weight matrix can have a respective value that characterizes synaptic connectivity in the brain of the biological organism between the respective pair of biological neuronal elements corresponding to the brain emulation parameter. For example, each brain emulation parameter of the weight matrix that corresponds to a respective pair of biological neuronal elements that are not connected by a biological (e.g., synaptic) connection in the brain of the biological organism can have value zero.

As another example, each brain emulation parameter of the weight matrix that corresponds to a respective pair of biological neuronal elements that are connected by a biological (e.g., synaptic) connection in the brain of the biological organism can have a respective non-zero value characterizing an estimated strength of the biological (e.g., synaptic) connection.

In yet another example, each brain emulation parameter of the weight matrix that corresponds to a respective pair of biological neuronal elements that are connected by a biological (e.g., synaptic) connection in the brain of the biological organism can have a respective non-zero value that is based on a proximity of the pair of biological neuronal elements in the brain.

In some implementations, for each of multiple community sub-graphs, the system can determine a respective set of features characterizing the community sub-graph, including a feature that predicts a biological function of the corresponding community of biological neuronal elements in the brain of the biological organism.

The system can instantiate each candidate neural network architecture by selecting one or more community sub-graphs for inclusion in the architecture, and instantiating the candidate neural network architecture to include a respective brain emulation sub-network corresponding to each of the community sub-graphs selected for inclusion in the candidate neural network architecture. The system can select one or more community sub-graphs based at least in part on the respective set of features characterizing each of the one or more community sub-graphs.

FIG. 5 is a block diagram of an example neural network computing system 500 that includes a neural network (e.g., a brain emulation sub-network 530) having an architecture that is specified by one or more community sub-graphs of a synaptic connectivity graph (e.g., as described above with reference to FIG. 2). The neural network computing system 500 is an example of a system implemented as computer programs on one or more computers in one or more locations in which the systems, components, and techniques described below are implemented.

The neural network computing system 500 can be implemented as a neural network 502 that includes multiple sub-networks: (i) an encoder 510 (ii) the brain emulation sub-network 530, and (iii) a decoder 550. The neural network 502 is configured to process a network input 504 to generate a network output 506 for a particular machine learning task. The network input 504 can be any kind of digital data input, and the network output 506 can be any kind of score, classification, or regression output based on the input. That is, the neural network 502 can be configured for any appropriate machine learning task, e.g., a classification task, a regression task, a segmentation task, an agent control task, a combination thereof, or any other appropriate task.

The encoder 510 is configured to process the network input 504 to generate an encoded representation of the network input, e.g., an embedding of the network input. Generally, an “embedding” refers to an ordered collection of numerical values such as, e.g., a vector or a matrix of numerical values. The encoder 510 can include one or more trained neural network layers, e.g., fully-connected layers, convolutional layers, attention layers, or any other appropriate layers. In some implementations, in addition to the one or more trained neural network layers, the encoder 510 can include one or more brain emulation sub-networks (e.g., sub-networks having an architecture that is specified by one or more respective community sub-graphs, as described above with reference to FIG. 2).

The embedding of the network input can be provided to the brain emulation sub-network 530 as the brain emulation sub-network input 522. The brain emulation sub-network 530 can be configured to process the brain emulation sub-network input 522 to generate a brain emulation sub-network output 532. The architecture of the brain emulation sub-network 530 can be selected by an optimization system as described above with reference to FIG. 2.

As described in more detail below with reference to FIG. 6, the synaptic connectivity graph (or a community sub-graph of the synaptic connectivity graph) can be represented using an adjacency matrix, all of which or a portion of which can be used as a weight matrix. In some implementations, the architecture of the brain emulation sub-network 530 can be represented by the weight matrix. The brain emulation sub-network 530 can apply the weight matrix to the brain emulation sub-network input 522 to generate the brain emulation sub-network output 532. Generally “applying” a matrix can refer to, e.g., performing a multiplication with the matrix. Each element of the weight matrix can be a respective brain emulation parameter of the brain emulation sub-network 530.

For example, the brain emulation sub-network input 522 can include an N×1 vector of elements, the weight matrix of the brain emulation sub-network 530 can be an M×N matrix of elements, and the brain emulation sub-network output 532 can be an M×1 vector of elements. In some implementations, a non-linear activation function (e.g., ReLU, or sigmoid activation function) can be applied to the result of the matrix multiplication with the matrix that represents the brain emulation parameters.

Each brain emulation parameter of the weight matrix can correspond to a pair of neuronal elements (e.g., neurons, groups of neurons, or portions of neurons) in the brain of the biological organism, where the value of the brain emulation parameter characterizes a strength of a biological connection between the pair of respective neuronal elements. In other words, each row and column of the weight matrix can correspond to a respective neuronal element in the brain of the biological organism, and the value of each brain emulation parameter can characterize a strength of a biological connection between (i) the neuronal element corresponding to the row of the brain emulation parameter and (ii) the neuronal element corresponding to the column of the brain emulation parameter.

For example, the weight matrix can be an M×N matrix, where each of the M rows corresponds to a neuronal element in a first set of neuronal elements and each of the N columns corresponds to a neuronal element in a second set of neuronal elements in the brain of the biological organism. The first set of neuronal elements and the second set of neuronal elements can be overlapping (i.e., one or more neuronal elements in the brain of the biological organism can be included in both sets) or disjoint (i.e., where no neuronal elements in the brain of the biological organism are included both sets). As a particular example, the first set and the second set can be the same. That is, the weight matrix can be an N×N matrix where the same neuronal elements in the brain of the biological organism are represented by both the rows and the columns of the weight matrix.

The decoder 550 of the neural network 502 is configured to process the brain emulation sub-network output 532 to generate the network output 506. The decoder 550 can include one or more trained neural network layers, e.g., fully-connected layers, convolutional layers, attention layers, or any other appropriate layers.

In some implementations, in addition to the one or more trained neural network layers, the decoder 550 can include one or more brain emulation sub-networks (e.g., sub-networks having an architecture that is determined by one or more respective community sub-graphs, as described above with reference to FIG. 2). In some implementations, in addition to processing the brain emulation sub-network output 532 generated by the brain emulation sub-network 530, the decoder sub-network 550 can additionally process one or more intermediate outputs of the brain emulation sub-network 530.

Generally, the neural network 502 can have any appropriate neural network architecture that allows it to perform its described function. In some implementations, the neural network 502 can be an autoencoder neural network, where the encoder sub-network 510 is the encoder of the autoencoder and the decoder sub-network 550 is the decoder of the autoencoder. For example, the neural network 502 can be an autoencoder neural network that is configured to generate an embedding of the network input 504 (e.g., using the encoder sub-network 510, where the embedding is the brain emulation sub-network input 522) and process the embedding to reconstruct the network input (e.g., using the decoder sub-network 550, where the network output 506 is a predicted reconstruction of the network input 504). For example, the neural network 502 can be a variational autoencoder that models the latent space of the generated embeddings using a mixture of distributions.

The neural network computing system 500 can further include a training engine that is configured to train the neural network 502.

In some implementations, the model parameters of the brain emulation sub-network 530 are untrained. Instead, the model parameters of the brain emulation sub-network 530 can be determined before training of the neural network 502 based on the weight values of the edges in the synaptic connectivity graph, or a community sub-graph of the synaptic connectivity graph. Optionally, the weight values of the edges in the graph can be transformed (e.g., by additive random noise) prior to being used for specifying model parameters of the brain emulation sub-network 530. This procedure enables the neural network 502 to take advantage of the information from the graph encoded into the brain emulation sub-network 530 in performing prediction tasks.

Therefore, rather than training the entire neural network 502 from end-to-end, the training engine can optionally train only the model parameters of the encoder sub-network 510 and the decoder sub-network 550, while leaving the model parameters of the brain emulation sub-network 530 fixed during training. In other words, the model parameters of one or more of the respective brain emulation sub-networks 530 included in the neural network 502 can be left untrained while training some or all of the other parameters of the neural network 502.

The training engine can train the neural network 502 on a set of training data over multiple training iterations. The training data can include a set of training examples, where each training example specifies: (i) a training network input, and (ii) a target network output that should be generated by the neural network 502 by processing the training network input.

At each training iteration, the training engine can sample a batch of training examples from the training data, and process the training inputs specified by the training examples using the neural network 502 to generate corresponding network outputs 506. In particular, for each training input, the neural network 502 processes the training input using the current model parameter values of the encoder 510 to generate the brain emulation sub-network input 522.

The neural network 502 processes the brain emulation sub-network input 522 in accordance with the static model parameter values of the brain emulation sub-network 530 to generate the brain emulation sub-network output 532. The neural network 502 then processes the brain emulation sub-network output 532 using the current model parameter values of the decoder sub-network 550 to generate the network output 506 corresponding to the training input.

The training engine adjusts the model parameters values of the encoder sub-network 510 and the model parameter values of the decoder sub-network 550 to optimize an objective function that measures a similarity between: (i) the network outputs 506 generated by the neural network 502, and (ii) the target network outputs specified by the training examples. The objective function can be, e.g., a cross-entropy objective function, a squared-error objective function, or any other appropriate objective function.

To optimize the objective function, the training engine can determine gradients of the objective function with respect to the model parameters of the encoder 510 and the model parameters of the decoder 550, e.g., using backpropagation techniques. The training engine can then use the gradients to adjust the model parameter values of the encoder 510 and the decoder 550, e.g., using any appropriate gradient descent optimization technique, e.g., an RMSprop or Adam gradient descent optimization technique.

The training engine can use any of a variety of regularization techniques during training of the neural network 502. For example, the training engine can use a dropout regularization technique, such that certain artificial neurons of the neural network 502 are “dropped out” (e.g., by having their output set to zero) with a non-zero probability p>0 each time the neural network 502 processes a network input. Using the dropout regularization technique can improve the performance of the trained neural network 502, e.g., by reducing the likelihood of over-fitting.

As another example, the training engine can regularize the training of the neural network 502 by including a “penalty” term in the objective function that measures the magnitude of the model parameter values of the encoder 510 and the decoder 550. The penalty term can be, e.g., an L1 or L2 norm of the model parameter values of the encoder 510 and/or the model parameter values of the decoder 550.

In some other implementations, the model parameters of the brain emulation sub-network 530 are trained. That is, after initial values for the model parameters of the brain emulation sub-network 530 have been determined based on the weight values of the edges in the synaptic connectivity graph (or a community sub-graph of the synaptic connectivity graph), the training engine can update the weights of the model parameters, as described above with reference to the parameters of the encoder 510 and the decoder 550, e.g., using backpropagation and stochastic gradient descent.

The neural network 502 can be configured to perform any appropriate task. A few examples follow.

In one example, the neural network 502 can be configured to process network inputs 604 that represent sequences of audio data. For example, each input element in the network input 504 can be a raw audio sample or an input generated from a raw audio sample (e.g., a spectrogram), and the neural network 502 can process the sequence of input elements to generate network outputs 506 representing predicted text samples that correspond to the audio samples. That is, the neural network 502 can be a “speech-to-text” neural network.

As another example, each input element can be a raw audio sample or an input generated from a raw audio sample, and the neural network 502 can generate a predicted class of the audio samples, e.g., a predicted identification of a speaker corresponding to the audio samples. As a particular example, the predicted class of the audio sample can represent a prediction of whether the input audio example is a verbalization of a predefined work or phrase, e.g., a “wakeup” phrase of a mobile device. In some implementations, one or more weight matrices of the brain emulation sub-network 530 can be generated from a community sub-graph that represents connectivity between neuronal elements in an audio region of the brain, i.e., a region of the brain that processes auditory information (e.g., the auditory cortex).

In another example, the neural network 502 can be configured to process network inputs that represent sequences of text data. For example, each input element in the network input can be a text sample (e.g., a character, phoneme, or word) or an embedding of a text sample, and the neural network 502 can process the sequence of input elements to generate network outputs representing predicted audio samples that correspond to the text samples. That is, the neural network can be a “text-to-speech” neural network.

As another example, each input element can be an input text sample or an embedding of an input text sample, and the neural network can generate a network output representing a sequence of output text samples corresponding to the sequences of input text samples. As a particular example, the output text samples can represent the same text as the input text samples in a different language (i.e., the neural network can be a machine translation neural network). As another particular example, the output text samples can represent an answer to a question posed by the input text samples (i.e., the neural network can be a question-answering neural network).

As another example, the input text samples can represent two texts (e.g., as separated by a delimiter token), and the neural network can generate a network output representing a predicted similarity between the two texts. In some implementations, one or more weight matrices of the brain emulation sub-network 530 can be generated from a community sub-graph that represents connectivity between neuronal elements in a speech region of the brain, i.e., a region of the brain that is linked to speech production (e.g., Broca's area).

In another example, the neural network 502 can be configured to process network inputs representing one or more images, e.g., sequences of video frames. For example, each input element in the network input can be a video frame or an embedding of a video frame, and the neural network 502 can process the sequence of input elements to generate a network output representing a prediction about the video represented by the sequence of video frames.

As a particular example, the neural network 502 can be configured to track a particular object in each of the frames of the video, i.e., to generate a network output that includes a sequences of output elements, where each output elements represents a predicted location within a respective video frames of the particular object.

As another example, the neural network 502 can be configured to process a video to generate a classification of the video in a class from a predetermined set of classes. The classes can be, e.g., action classes, where each action class corresponds to a possible type of action (e.g., sitting, standing, walking, etc.), and a video is classified as being included in the action class if the video shows a person performing the action corresponding to the action class. In some implementations, the brain emulation sub-network 208 can be generated from a community sub-graph that represents connectivity between neuronal elements in a visual region of the brain, i.e., a region of the brain that processes visual information (e.g., the visual cortex).

In another example, the neural network 502 can be configured to process a network input representing a respective current state of an environment at each of one or more time points, and to generate a network output representing action selection outputs that can be used to select actions to be performed at respective time points by an agent interacting with the environment.

For example, each action selection output can specify a respective score for each action in a set of possible actions that can be performed by the agent, and the agent can select the action to be performed by sampling an action in accordance with the action scores. In one example, the agent can be a mechanical agent interacting with a real-world environment to perform a navigation task (e.g., reaching a goal location in the environment), and the actions performed by the agent cause the agent to navigate through the environment.

After training, the neural network 502 can be directly applied to perform prediction tasks. For example, the neural network 502 can be deployed onto a user device. In some implementations, the neural network 502 can be deployed directly into resource-constrained environments (e.g., mobile devices). Neural networks 602 that include brain emulation sub-networks 630 having an architecture that is specified by a community sub-graph can generally perform at a high level, e.g., in terms of prediction accuracy, even with very few model parameters, when compared to other neural networks.

For example, neural networks 602 as described in this specification that have, e.g., 100 or 900 model parameters can achieve comparable performance to other neural networks that have millions of model parameters. Thus, the neural network 502 can be implemented efficiently and with low latency on user devices.

In some implementations, after the neural network 502 has been deployed onto a user device, some of the parameters of the neural network 502 can be further trained, i.e., “fine-tuned,” using new training examples obtained by the user device. For example, some of the parameters can be fine-tuned using training examples corresponding to the specific user of the user device, so that the neural network 502 can achieve a higher accuracy for inputs provided by the specific user. As a particular example, the model parameters of the encoder 510 and/or the decoder 550 can be fine-tuned on the user device using new training examples while the model parameters of the brain emulation sub-network 530 are held static, as described above.

FIG. 6 illustrates an example weight matrix 601 of a brain emulation neural network (e.g., the brain emulation sub-network 530 in FIG. 1) having an architecture that is specified by a community sub-graph (e.g., the sub-graph 340 in FIG. 3) of a synaptic connectivity graph (e.g., the graph 108 in FIG. 1).

As described in more detail below with reference to FIG. 7, a graphing system (e.g., the graphing system 712 in FIG. 7), can generate the synaptic connectivity graph that represents synaptic connectivity between neuronal elements in the brain of a biological organism. Generally, the synaptic connectivity graph can be represented using a two-dimensional array of numerical values (e.g., an adjacency matrix) with a number of rows and columns equal to the number of nodes in the synaptic connectivity graph. As described in more detail above with reference to FIGS. 2 and 3, an optimization system can partition the synaptic connectivity graph into multiple community sub-graphs representing connectivity between neuronal elements that belong to a community of neuronal elements in the brain of the biological organism.

The community sub-graph can be represented using a portion of the adjacency matrix, e.g., the weight matrix 601, that can specify the brain emulation parameters of a neural network architecture that is specified by the community sub-graph of the synaptic connectivity graph (e.g., the brain emulation neural network, or sub-network).

As illustrated in FIG. 6, the weight matrix 601 includes n2 elements, where n is the number of neuronal elements drawn from a community of biological neuronal elements in the brain of the biological organism, the community being represented by the community sub-graph. For example, the weight matrix 601 can include hundreds, thousands, tens of thousands, hundreds of thousands, millions, tens of millions, or hundreds of millions of elements. As a particular example, the number of elements n can equal the number of nodes in the community sub-graph.

Each element of the weight matrix 601 represents connectivity between a respective pair of neuronal elements in the set of n neuronal elements. That is, each element ci,j identifies the biological connection between, e.g., neuron i and neuron j. In some implementations, each of the elements ci,j are either zero (e.g., indicating that there is no biological connection between the corresponding neuronal elements) or one (e.g., indicating that there is a biological connection between the corresponding neuronal elements). In some implementations, each element ci,j is a scalar value representing the strength of the biological connection between the corresponding neuronal elements.

Each row of the weight matrix 601 can represent a respective neuronal element in a first set of neuronal elements in a community of neuronal elements in the brain of the biological organism, and each column of the weight matrix 601 can represent a respective neuronal element in a second set in a community of neuronal elements in the brain of the biological organism. Generally, the first set and the second set can be overlapping, or disjoint. In some implementations, the first set and the second set can be the same.

In implementations where the community sub-graph is undirected (e.g., where the edges in the graph are not associated with a direction), the weight matrix 601 is symmetric (i.e., each element ci,j is the same as element cj,i). In implementations where the community sub-graph is directed (e.g., where each edge in the graph is associated with a direction that can correspond to, e.g., the direction of the synapse that the edge represents), the weight matrix 601 is not symmetric (i.e., there may exist elements ci,j and cj,i such that c_{i,j}≠c_{j,i}).

The above example is provided for illustrative purposes only, and generally the elements of the weight matrix 601 can correspond to pairs of any appropriate type of neuronal element, and any number of communities of neuronal elements in the brain of the biological organism. For example, each element can correspond to a pair of voxels in a voxel grid of the brain of the biological organism. As another example, each element can correspond to a pair of sub-neurons, or parts of neurons, of the brain of the biological organism. As another example, each element can correspond to a pair of sets of multiple neurons of the brain of the biological organism.

As described in more detail below, an architecture mapping system (e.g., the architecture mapping system 208 in FIG. 2, or the architecture mapping system 800 in FIG. 8) can generate the weight matrix 601. In some implementations, the weight matrix 601 can represent neuronal elements only of a particular type in the brain of the biological organism. Although the weight matrix 601 of the brain emulation neural network is illustrated as having only a few brain emulation parameters, the weight matrix 601 can generally have significantly more brain emulation parameters, e.g., hundreds, thousands, or millions of brain emulation parameters. Further, the weight matrix 601 can have any appropriate dimensionality.

FIG. 7 illustrates an example data flow 700 for generating a synaptic connectivity graph 702 based on the brain 706 of a biological organism.

An imaging system 708 can be used to generate a synaptic resolution image 710 of the brain 706. An image of the brain 706 may be referred to as having synaptic resolution if it has a spatial resolution that is sufficiently high to enable the identification of at least some synapses in the brain 706. Put another way, an image of the brain 706 may be referred to as having synaptic resolution if it depicts the brain 706 at a magnification level that is sufficiently high to enable the identification of at least some synapses in the brain 706. The image 710 can be a volumetric image, i.e., that characterizes a three-dimensional representation of the brain 706. The image 710 can be represented in any appropriate format, e.g., as a three-dimensional array of numerical values.

The imaging system 708 can be any appropriate system capable of generating synaptic resolution images, e.g., an electron microscopy system. The imaging system 708 can process “thin sections” from the brain 706 (i.e., thin slices of the brain attached to slides) to generate output images that each have a field of view corresponding to a proper subset of a thin section. The imaging system 708 can generate a complete image of each thin section by stitching together the images corresponding to different fields of view of the thin section using any appropriate image stitching technique.

The imaging system 708 can generate the volumetric image 710 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

In some implementations, the imaging system 708 can be a two-photon endomicroscopy system that utilizes a miniature lens implanted into the brain to perform fluorescence imaging. This system enables in-vivo imaging of the brain at the synaptic resolution. Example techniques for generating a synaptic resolution image of the brain using two-photon endomicroscopy are described with reference to: Z. Qin, et al., “Adaptive optics two-photon endomicroscopy enables deep-brain imaging at synaptic resolution over large volumes,” Science Advances, Vol. 6, no. 40, doi: 10.1126/sciadv.abc6521.

A graphing system 712 is configured to process the synaptic resolution image 710 to generate the synaptic connectivity graph 702. The synaptic connectivity graph 702 specifies a set of nodes and a set of edges, such that each edge connects two nodes. To generate the graph 702, the graphing system 712 identifies each neuronal element (e.g., a neuron, a group of neurons, or a portion of a neuron) in the image 710 as a respective node in the graph, and identifies each biological connection between a pair of neuronal elements in the image 710 as an edge between the corresponding pair of nodes in the graph.

The graphing system 712 can identify the neuronal elements and biological connections between neuronal elements depicted in the image 710 using any of a variety of techniques. For example, the graphing system 712 can process the image 710 to identify the positions of the neurons depicted in the image 610, and determine whether a biological connection exists between two neurons based on the proximity of the neurons (as will be described in more detail below).

In this example, the graphing system 712 can process an input including: (i) the image, (ii) features derived from the image, or (iii) both, using a machine learning model that is trained using supervised learning techniques to identify neurons in images. The machine learning model can be, e.g., a convolutional neural network model or a random forest model. The output of the machine learning model can include a neuron probability map that specifies a respective probability that each voxel in the image is included in a neuron. The graphing system 712 can identify contiguous clusters of voxels in the neuron probability map as being neurons.

Optionally, prior to identifying the neurons from the neuron probability map, the graphing system 712 can apply one or more filtering operations to the neuron probability map, e.g., with a Gaussian filtering kernel. Filtering the neuron probability map can reduce the amount of “noise” in the neuron probability map, e.g., where only a single voxel in a region is associated with a high likelihood of being a neuron.

The machine learning model used by the graphing system 712 to generate the neuron probability map can be trained using supervised learning training techniques on a set of training data. The training data can include a set of training examples, where each training example specifies: (i) a training input that can be processed by the machine learning model, and (ii) a target output that should be generated by the machine learning model by processing the training input.

For example, the training input can be a synaptic resolution image of a brain, and the target output can be a “label map” that specifies a label for each voxel of the image indicating whether the voxel is included in a neuron. The target outputs of the training examples can be generated by manual annotation, e.g., where a person manually specifies which voxels of a training input are included in neurons.

Example techniques for identifying the positions of neurons depicted in the image 710 using neural networks (in particular, flood-filling neural networks) are described with reference to: P. H. Li et al.: “Automated Reconstruction of a Serial-Section EM Drosophila Brain with Flood-Filling Networks and Local Realignment,” bioRxiv doi:10.1101/605634 (2019).

The graphing system 712 can identify biological connections between neuronal elements in the image 710 based on the proximity of the neuronal elements. For example, the graphing system 712 can determine that a first neuronal element is connected by a biological connection to a second neuronal element based on the area of overlap between: (i) a tolerance region in the image around the first neuronal element, and (ii) a tolerance region in the image around the second neuronal element. That is, the graphing system 712 can determine whether the first neuronal element and the second neuronal element are connected based on the number of spatial locations (e.g., voxels) that are included in both: (i) the tolerance region around the first neuronal element, and (ii) the tolerance region around the second neuronal element.

As a particular example, the graphing system 712 can determine that two neurons are connected if the overlap between the tolerance regions around the respective neurons includes at least a predefined number of spatial locations (e.g., one spatial location). A “tolerance region” around a neuronal element refers to a contiguous region of the image that includes the neuronal element. As a particular example, the tolerance region around a neuron can be specified as the set of spatial locations in the image that are either: (i) in the interior of the neuron, or (ii) within a predefined distance of the interior of the neuron.

The graphing system 712 can further identify a weight value associated with each edge in the graph 702. For example, the graphing system 712 can identify a weight for an edge connecting two nodes in the graph 702 based on the area of overlap between the tolerance regions around the respective neurons (or any other neuronal elements) corresponding to the nodes in the image 710 (e.g., based on a proximity of the respective neurons or other neuronal elements). The area of overlap can be measured, e.g., as the number of voxels in the image 710 that are contained in the overlap of the respective tolerance regions around the neurons. The weight for an edge connecting two nodes in the graph 702 may be understood as characterizing the (approximate) strength of the biological connection between the corresponding neuronal elements in the brain (e.g., the amount of information flow through the biological connection connecting the two neuronal elements).

In addition to identifying biological connections in the image 710, the graphing system 712 can further determine the direction of each biological connection using any appropriate technique. The “direction” of a biological connection between two neuronal elements refers to the direction of information flow between the two neuronal elements, e.g., if a first neuron uses a synapse to transmit signals to a second neuron, then the direction of the synapse would point from the first neuron to the second neuron. Example techniques for determining the directions of synapses connecting pairs of neurons are described with reference to: C. Seguin, A. Razi, and A. Zalesky: “Inferring neural signalling directionality from undirected structure connectomes,” Nature Communications 10, 4289 (2019), doi:10.1038/s41467-019-12201-w.

In implementations where the graphing system 712 determines the directions of the synapses in the image 710, the graphing system 712 can associate each edge in the graph 702 with the direction of the corresponding synapse. That is, the graph 702 can be a directed graph. In some other implementations, the graph 702 can be an undirected graph, i.e., where the edges in the graph are not associated with a direction.

The graph 702 can be represented in any of a variety of ways. For example, as described above with reference to FIG. 6, the graph 702 can be represented as a two-dimensional array of numerical values with a number of rows and columns equal to the number of nodes in the graph. The component of the array at position (i,j) can have value 1 if the graph includes an edge pointing from node i to node j, and value 0 otherwise. In implementations where the graphing system 712 determines a weight value for each edge in the graph 702, the weight values can be similarly represented as a two-dimensional array of numerical values. More specifically, if the graph includes an edge connecting node i to node j, the component of the array at position (i,j) can have a value given by the corresponding edge weight, and otherwise the component of the array at position (i,j) can have value 0.

An example architecture mapping system will be described in more detail next.

FIG. 8 is a block diagram of an example architecture mapping system 800 (e.g., the architecture mapping system 208 in FIG. 2). The architecture mapping system 800 is an example of a system implemented as computer programs on one or more computers in one or more locations in which the systems, components, and techniques described below are implemented.

As described above with reference to FIG. 2, the architecture mapping system 800 can process a community sub-graph of a synaptic connectivity graph, representing a community of biological neuronal elements in the brain of a biological organism, to determine a corresponding brain emulation neural network architecture 802 of a brain emulation neural network 816. The architecture mapping system 800 can determine the architecture 802 using a transformation engine 804, or a feature generation engine 806, each of which will be described in more detail next.

The transformation engine 804 can be configured to apply one or more transformation operations to the community sub-graph 801 that alter the connectivity of the community sub-graph 801, i.e., by adding or removing edges from the graph. A few examples of transformation operations follow.

In one example, to apply a transformation operation to the community sub-graph 801, the transformation engine 804 can randomly sample a set of node pairs from the sub-graph (i.e., where each node pair specifies a first node and a second node). For example, the transformation engine can sample a predefined number of node pairs in accordance with a uniform probability distribution over the set of possible node pairs. For each sampled node pair, the transformation engine 804 can modify the connectivity between the two nodes in the node pair with a predefined probability (e.g., 0.1%).

In one example, the transformation engine 804 can connect the nodes by an edge (i.e., if they are not already connected by an edge) with the predefined probability. In another example, the transformation engine 804 can reverse the direction of any edge connecting the two nodes with the predefined probability. In another example, the transformation engine 804 can invert the connectivity between the two nodes with the predefined probability, i.e., by adding an edge between the nodes if they are not already connected, and by removing the edge between the nodes if they are already connected.

In another example, the transformation engine 804 can apply a convolutional filter to a representation of the community sub-graph 801 as a two-dimensional array of numerical values. As described above with reference to FIG. 6, the community sub-graph 801 can be represented as a two-dimensional array of numerical values where the component of the array at position (i,j) can have value 1 if the graph includes an edge pointing from node i to node j, and value 0 otherwise. The convolutional filter can have any appropriate kernel, e.g., a spherical kernel or a Gaussian kernel.

After applying the convolutional filter, the transformation engine 804 can quantize the values in the array representing the graph, e.g., by rounding each value in the array to 0 or 1, to cause the array to unambiguously specify the connectivity of the graph. Applying a convolutional filter to the representation of the community sub-graph 801 can have the effect of regularizing the graph, e.g., by smoothing the values in the array representing the graph to reduce the likelihood of a component in the array having a different value than many of its neighbors.

In some cases, the community sub-graph 801 can include some inaccuracies in representing the connectivity in the biological brain. For example, the sub-graph can include nodes that are not connected by an edge despite the corresponding neuronal elements in the brain being connected, or “spurious” edges that connect nodes in the sub-graph despite the corresponding neuronal elements in the brain not being connected.

Inaccuracies in the sub-graph can result, e.g., from imaging artifacts or ambiguities in the synaptic resolution image of the brain that is processed to generate the graph. Regularizing the sub-graph, e.g., by applying a convolutional filter to the representation of the sub-graph, can increase the accuracy with which the community sub-graph represents the connectivity between a community of biological neuronal elements in the brain, e.g., by removing spurious edges.

As described above with reference to FIG. 1, some biological communities of biological neuronal elements in the brain of the biological organism can be functionally-specialized. In some implementations, the community sub-graph 801, representing a community of biological neuronal elements in the brain, can include a “nucleus” or a “cluster” representing a group of related neuronal elements in the brain, e.g., a thalamic nucleus, a vestibular nucleus, a dentate nucleus, or a fastigial nucleus. Each of such nuclei in community sub-graphs 801 can be associated with a respective set of features that can include, e.g., the number of edges in the cluster, the average of the node features corresponding to each node that is connected by an edge in the cluster, both of these features, or any other appropriate feature.

The architecture mapping system 800 can determine a respective set of features characterizing the community sub-graph 801, including a feature that predicts a biological function of the corresponding community of biological neuronal elements in the brain of the biological organism, e.g., a visual function by processing visual data, an olfactory function by processing odor data, or a memory function by retaining information. For example, the architecture mapping system 800 can use the feature generation engine 806 and the node classification engine 808 to determine predicted “types” of neuronal elements corresponding to the nodes in the community sub-graph 801.

Generally, the type of a neuronal element can characterize any appropriate aspect of the neuronal element. In some implementations, after identifying the types of the neuronal elements corresponding to the nodes in multiple community sub-graphs 801, the architecture mapping system 800 can identify a particular community sub-graph 801 based on the neuronal element types, and determine the neural network architecture 802 based on the particular community sub-graph. The feature generation engine 806 and the node classification engine 808 will be described in more detail next.

The feature generation engine 806 can be configured to process the community sub-graph 801 (potentially after it has been modified by the transformation engine 804) to generate one or more respective node features 814 corresponding to each node of the community sub-graph 801. The node features corresponding to a node can characterize the topology (i.e., connectivity) of the community sub-graph relative to the node. In one example, the feature generation engine 806 can generate a node degree feature for each node in the community sub-graph 801, where the node degree feature for a given node specifies the number of other nodes that are connected to the given node by an edge.

In another example, the feature generation engine 806 can generate a path length feature for each node in the community sub-graph 801, where the path length feature for a node specifies the length of the longest path in the graph starting from the node. A path in the graph may refer to a sequence of nodes in the graph, such that each node in the path is connected by an edge to the next node in the path.

The length of a path in the graph may refer to the number of nodes in the path. In another example, the feature generation engine 806 can generate a neighborhood size feature for each node in the community sub-graph 801, where the neighborhood size feature for a given node specifies the number of other nodes that are connected to the node by a path of length at most N. In this example, N can be a positive integer value.

In another example, the feature generation engine 806 can generate an information flow feature for each node in the community sub-graph 801. The information flow feature for a given node can specify the fraction of the edges connected to the given node that are outgoing edges, i.e., the fraction of edges connected to the given node that point from the given node to a different node.

In some implementations, the feature generation engine 806 can generate one or more node features that do not directly characterize the topology of the community sub-graph 801 relative to the nodes. In one example, the feature generation engine 806 can generate a spatial position feature for each node in the community sub-graph 801, where the spatial position feature for a given node specifies the spatial position in the brain of the neuronal element corresponding to the node, e.g., in a Cartesian coordinate system of the image of the brain.

In another example, the feature generation engine 806 can generate a feature for each node in the community sub-graph 801 (e.g., where the node represents a biological neuron) indicating whether the corresponding neuron is excitatory or inhibitory. In another example, the feature generation engine 806 can generate a feature for each node in the community sub-graph 801 that identifies the neuropil region associated with the neuron corresponding to the node.

In some cases, the feature generation engine 806 can use weights associated with the edges in the community sub-graph 801 in determining the node features 814. As described above, a weight value for an edge connecting two nodes can be determined, e.g., based on the area of any overlap between tolerance regions around the neuronal elements corresponding to the nodes. In one example, the feature generation engine 806 can determine the node degree feature for a given node as a sum of the weights corresponding to the edges that connect the given node to other nodes in the graph. In another example, the feature generation engine 806 can determine the path length feature for a given node as a sum of the edge weights along the longest path in the graph starting from the node.

The node classification engine 808 can be configured to process the node features 814 to identify a predicted neuronal element type 810 corresponding to certain nodes of the community sub-graph 801. In one example, the node classification engine 808 can process the node features 814 to identify a proper subset of the nodes in the community sub-graph 801 with the highest values of the path length feature.

For example, the node classification engine 808 can identify the nodes with a path length feature value greater than the 90th percentile (or any other appropriate percentile) of the path length feature values of all the nodes in the graph. The node classification engine 808 can then associate the identified nodes having the highest values of the path length feature with the predicted neuronal element type, e.g., if the neuronal element represented by the node is a neuron, the node classification engine can identify it as a “primary sensory neuron.”

In another example, the node classification engine 808 can process the node features 814 to identify a proper subset of the nodes in the community sub-graph 801 with the highest values of the information flow feature, i.e., indicating that many of the edges connected to the node are outgoing edges. The node classification engine 808 can then associate the identified nodes having the highest values of the information flow feature with the predicted neuronal element type, e.g., if the neuronal element represented by the node is a neuron, the node classification engine can identify it as a “sensory neuron.”

In another example, the node classification engine 808 can process the node features 814 to identify a proper subset of the nodes in the community sub-graph 801 with the lowest values of the information flow feature, i.e., indicating that many of the edges connected to the node are incoming edges (i.e., edges that point towards the node). The node classification engine 808 can then associate the identified nodes having the lowest values of the information flow feature with the predicted neuron type, e.g., if the neuronal element represented by the node is a neuron, the node classification engine can identify it as an “associative neuron.”

As described above with reference to FIG. 2, the architecture mapping system 800 can select one or more community sub-graphs 801 for inclusion in the brain emulation neural network architecture 802 (or a candidate neural network architecture, such as the architecture 210 in FIG. 2) based on one or more features that characterize each of the community sub-graphs 801.

For example, the system 800 can select a community sub-graph 801 that includes the largest number of nodes that represent neuronal elements of a particular type (e.g., sensory neurons), and instantiate the corresponding brain emulation neural network architecture 802. In some implementations, the architecture mapping system 800 can select one or more community sub-graphs 801 based on different types of neuronal elements e.g., both visual neurons and olfactory neurons.

In another example, the system 800 can select a community sub-graph 801 based on the spatial position of neuronal elements in the brain that the community sub-graph 801 represents. As described above, the feature generation engine 806 can generate the spatial position feature for each node in the community sub-graph 801, where the spatial position feature for a given node specifies the spatial position in the brain of the neuronal element corresponding to the node, e.g., in a Cartesian coordinate system of the image of the brain.

If an approximate position of a particular region of the brain that includes neuronal elements that perform a particular function is known (e.g., the approximate position of the visual cortex region of the brain including neuronal elements that process visual data), the system 800 can select the community sub-graph 801 that represents neuronal elements having an approximate centroid position that corresponds to the approximate position of that particular region in the brain. The community sub-graph 801 selected for inclusion in the brain emulation neural network architecture 802 (or the candidate neural network architecture 210 in FIG. 2) can be determined based on the task which the brain emulation neural network 816 will be configured to perform. In one example, the brain emulation neural network 816 can be configured to perform an image processing task, and a community sub-graph 801 that represents a community of biological neuronal elements that are predicted to perform visual functions (i.e., by processing visual data) can be selected for inclusion in the neural network architecture 802.

In another example, the brain emulation neural network 816 can be configured to perform an odor processing task, and a community sub-graph 801 that represents a community of biological neuronal elements that are predicted to perform odor processing functions (i.e., by processing odor data) can be selected for inclusion in the architecture 802.

In another example, the brain emulation neural network 816 can be configured to perform an audio processing task, and a community sub-graph 801 that represents neuronal elements that are predicted to perform audio processing (i.e., by processing audio data) can be selected for inclusion in the neural network architecture 802.

Determining the architecture 802 of the brain emulation neural network 816 based on the community sub-graph 801 of the synaptic connectivity graph, e.g., based on natural community structure of biological neuronal elements in the brain of the biological organism, can ensure that the majority of elements that are relevant to solving a particular task are included in the architecture 802, while minimizing elements in the architecture 802 that are not relevant to solving the task.

This is in contrast to determining a neural network architecture based on a sub-graph of the synaptic connectivity graph that represents an unnatural predefined geometrical region, e.g., a cubical region, of the brain of the biological organism, and that can therefore include a substantial amount of “noise” elements that are not relevant to solving a particular task. The architecture 802 of the brain emulation neural network 816 can therefore be more effective at solving the task than other (e.g., un-natural) neural network architectures, while consuming fewer computational resources.

The architecture mapping system 800 can determine the architecture 802 of the brain emulation neural network 816 from the community sub-graph 801 in any of a variety of ways. For example, the architecture mapping system 800 can map each node in the sub-graph 801 to a corresponding: (i) artificial neuron, (ii) artificial neural network layer, or (iii) group of artificial neural network layers in the architecture 802, as will be described in more detail next.

In one example, the neural network architecture 802 can include: (i) a respective artificial neuron corresponding to each node in the sub-graph 801, and (ii) a respective connection corresponding to each edge in the sub-graph 801. In this example, the sub-graph 801 can be a directed graph, and an edge that points from a first node to a second node in the sub-graph 801 can specify a connection pointing from a corresponding first artificial neuron to a corresponding second artificial neuron in the architecture 802.

The connection pointing from the first artificial neuron to the second artificial neuron can indicate that the output of the first artificial neuron should be provided as an input to the second artificial neuron. Each connection in the architecture can be associated with a weight value, e.g., that is specified by the weight value associated with the corresponding edge in the sub-graph. An artificial neuron may refer to a component of the architecture 802 that is configured to receive one or more inputs (e.g., from one or more other artificial neurons), and to process the inputs to generate an output. The inputs to an artificial neuron and the output generated by the artificial neuron can be represented as scalar numerical values.

In one example, a given artificial neuron can generate an output b as:

$$b = σ ( {\sum }_{i = 1}^{n} {w}_{i} \cdot {a}_{i} ) \qquad ( 3 )$$

where σ(⋅) is a non-linear “activation” function (e.g., a sigmoid function or an arctangent function), {aᵢ}ᵢ₌₁ⁿ are the inputs provided to the given artificial neuron, and {wᵢ}ᵢ₌₁ⁿ are the weight values associated with the connections between the given artificial neuron and each of the other artificial neurons that provide an input to the given artificial neuron.

In another example, the community sub-graph 801 can be an undirected graph, and the architecture mapping system 800 can map an edge that connects a first node to a second node in the sub-graph 801 to two connections between a corresponding first artificial neuron and a corresponding second artificial neuron in the architecture. In particular, the architecture mapping system 800 can map the edge to: (i) a first connection pointing from the first artificial neuron to the second artificial neuron, and (ii) a second connection pointing from the second artificial neuron to the first artificial neuron.

In another example, the community sub-graph 801 can be an undirected graph, and the architecture mapping system can map an edge that connects a first node to a second node in the sub-graph 801 to one connection between a corresponding first artificial neuron and a corresponding second artificial neuron in the architecture. The architecture mapping system 800 can determine the direction of the connection between the first artificial neuron and the second artificial neuron, e.g., by randomly sampling the direction in accordance with a probability distribution over the set of two possible directions.

In some cases, the edges in the community sub-graph 801 are not associated with weight values, and the weight values corresponding to the connections in the architecture 802 can be determined randomly. For example, the weight value corresponding to each connection in the architecture 802 can be randomly sampled from a predetermined probability distribution, e.g., a standard Normal (N(0,1)) probability distribution.

In another example, the neural network architecture 802 can include: (i) a respective artificial neural network layer corresponding to each node in the community sub-graph 801, and (ii) a respective connection corresponding to each edge in the community sub-graph 801. In this example, a connection pointing from a first layer to a second layer can indicate that the output of the first layer should be provided as an input to the second layer. An artificial neural network layer may refer to a collection of artificial neurons, and the inputs to a layer and the output generated by the layer can be represented as ordered collections of numerical values (e.g., tensors of numerical values).

In one example, the architecture 802 can include a respective convolutional neural network layer corresponding to each node in the sub-graph 801, and each given convolutional layer can generate an output d as:

$$d = σ ( {h}_{θ} ( {\sum }_{i = 1}^{n} {w}_{i} \cdot {c}_{i} ) ) \qquad ( 4 )$$

where each cᵢ (i=1, . . . , n) is a tensor (e.g., a two- or three-dimensional array) of numerical values provided as an input to the layer, each wᵢ (i=1, . . . , n) is a weight value associated with the connection between the given layer and each of the other layers that provide an input to the given layer (where the weight value for each edge can be specified by the weight value associated with the corresponding edge in the sub-graph), h_{θ}(⋅) represents the operation of applying one or more convolutional kernels to an input to generate a corresponding output, and σ(⋅) is a non-linear activation function that is applied element-wise to each component of its input. In this example, each convolutional kernel can be represented as an array of numerical values, e.g., where each component of the array is randomly sampled from a predetermined probability distribution, e.g., a standard Normal probability distribution.

In another example, the architecture mapping system 800 can determine that the neural network architecture includes: (i) a respective group of artificial neural network layers corresponding to each node in the community sub-graph 801, and (ii) a respective connection corresponding to each edge in the sub-graph 801. The layers in a group of artificial neural network layers corresponding to a node in the sub-graph 801 can be connected, e.g., as a linear sequence of layers, or in any other appropriate manner.

The neural network architecture 802 can include one or more artificial neurons that are identified as “input” artificial neurons and one or more artificial neurons that are identified as “output” artificial neurons. An input artificial neuron may refer to an artificial neuron that is configured to receive an input from a source that is external to the brain emulation neural network 816. An output artificial neural neuron may refer to an artificial neuron that generates an output which is considered part of the overall output generated by the brain emulation neural network 816.

Various operations performed by the described architecture mapping system 800 are optional or can be implemented in a different order. For example, the architecture mapping system 800 can refrain from applying transformation operations to the community sub-graph 801 using the transformation engine 804. In this example, the architecture mapping system 800 can directly map the community sub-graph 801 to the neural network architecture 802, e.g., by mapping each node in the graph to an artificial neuron and mapping each edge in the graph to a connection in the architecture, as described above.

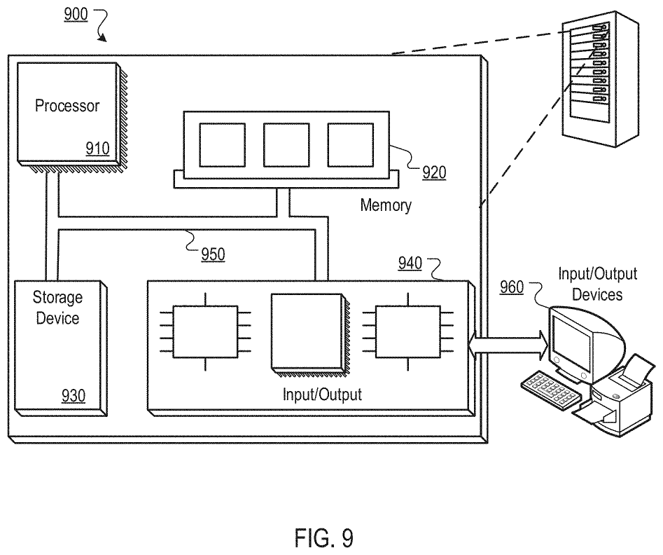

FIG. 9 is a block diagram of an example computer system 900 that can be used to perform operations described previously. The system 900 includes a processor 910, a memory 920, a storage device 930, and an input/output device 940. Each of the components 910, 920, 930, and 940 can be interconnected, for example, using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930.

The memory 920 stores information within the system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the system 900. In one implementation, the storage device 930 is a computer-readable medium. In various different implementations, the storage device 930 can include, for example, a hard disk device, an optical disk device, a storage device that is shared over a network by multiple computing devices (for example, a cloud storage device), or some other large capacity storage device.

The input/output device 940 provides input/output operations for the system 900. In one implementation, the input/output device 940 can include one or more network interface devices, for example, an Ethernet card, a serial communication device, for example, and RS-232 port, and/or a wireless interface device, for example, and 802.11 card. In another implementation, the input/output device 940 can include driver devices configured to receive input data and send output data to other input/output devices, for example, keyboard, printer and display devices 960. Other implementations, however, can also be used, such as mobile computing devices, mobile communication devices, and set-top box television client devices.

Although an example processing system has been described in FIG. 9, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus.

The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which can also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program can, but need not, correspond to a file in a file system.

A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry.

Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method performed by one or more data processing apparatus, the method comprising:
obtaining data defining a connectivity graph that represents synaptic connectivity between a plurality of biological neuronal elements in a brain of a biological organism, wherein the connectivity graph comprises: (i) a plurality of nodes, and (ii) a plurality of edges that each connect a respective pair of nodes;
determining a partition of the connectivity graph into a plurality of community sub-graphs by performing an optimization that encourages a higher measure of connectedness between nodes included within each community sub-graph relative to nodes included in different community sub-graphs; and
selecting a neural network architecture for performing a machine learning task using the plurality of community sub-graphs determined by the optimization that encourages the higher measure of connectedness between nodes included within each community sub-graph relative to nodes included in different community sub-graphs, comprising:
instantiating a plurality of candidate neural network architectures, wherein each candidate neural network architecture includes one or more brain emulation sub-networks that each have a respective architecture specified by a respective community sub-graph of the plurality of community sub-graphs;
determining a respective performance measure of each of the plurality of candidate neural network architectures on the machine learning task; and
selecting the neural network architecture for performing the machine learning task based on the performance measures of the plurality of candidate neural network architectures.

2. The method of claim 1, wherein each of the community sub-graphs is predicted to represent a corresponding community of biological neuronal elements in the brain of the biological organism.

3. The method of claim 2, further comprising, for each of the plurality of community sub-graphs:
determining a respective set of features characterizing the community sub-graph, including a feature that predicts a biological function of the corresponding community of biological neuronal elements in the brain of the biological organism.

4. The method of claim 3, wherein instantiating the plurality of candidate neural network architectures comprises, for each of the plurality of candidate neural network architectures:
selecting one or more community sub-graphs for inclusion in the candidate neural network architecture; and
instantiating the candidate neural network architecture to include a respective brain emulation sub-network corresponding to each of the community sub-graphs selected for inclusion in the candidate neural network architecture.

5. The method of claim 4, wherein for one or more of the plurality of candidate neural network architectures, selecting one or more community sub-graphs for inclusion in the candidate neural network architecture comprises:
selecting one or more community sub-graphs for inclusion in the candidate neural network architecture based at least in part on the respective set of features characterizing each of the plurality of community sub-graphs.

6. The method of claim 1, wherein each node in the connectivity graph corresponds to a respective biological neuronal element in the brain of the biological organism, and each edge connecting a pair of nodes in the connectivity graph represents synaptic connectivity between a pair of biological neuronal elements in the brain of the biological organism.

7. The method of claim 6, wherein the biological neuronal element in the brain of the biological organism is a biological neuron, a part of a biological neuron, or a group of biological neurons.

8. The method of claim 1, wherein determining a partition of the connectivity graph into a plurality of community sub-graphs by performing an optimization that encourages a higher measure of connectedness between nodes included within each community sub-graph relative to nodes included in different community sub-graphs comprises:
determining a betweenness score for each of the plurality of edges in the connectivity graph, wherein the betweenness score for an edge characterizes a likelihood that the edge connects a pair of nodes included in different community sub-graphs of the connectivity graph;
iteratively performing operations until a termination criterion is satisfied, the operations comprising:
removing one or more edges from the connectivity graph that have the betweenness score above a threshold;
removing one or more nodes from the connectivity graph that are not connected to any other nodes in the connectivity graph by an edge;
determining a new betweenness score for each of the plurality of the remaining edges in the connectivity graph; and
determining if the termination criterion is satisfied; and
after determining that the termination criterion is satisfied, determining a partition of the connectivity graph into the plurality of community sub-graphs.

9. The method of claim 8, wherein the betweenness score for the edge is a number of shortest paths between any two nodes in the connectivity graph that include the edge.

10. The method of claim 1, wherein determining a partition of the connectivity graph into a plurality of community sub-graphs by performing an optimization that encourages a higher measure of connectedness between nodes included within each community sub-graph relative to nodes included in different community sub-graphs comprises:
iteratively performing operations until a termination criterion is satisfied, the operations comprising:
selecting a first node in the connectivity graph;
determining a plurality of candidate connectivity graphs based on the first node;
determining a change in a modularity score for each of the candidate connectivity graphs;
based on the change in the modularity score, selecting a candidate connectivity graph from the plurality of candidate connectivity graphs as a new connectivity graph; and
determining if a termination criterion is satisfied; and
after determining that the termination criterion is satisfied, determining the partition of the connectivity graph into the plurality of community sub-graphs.

11. The method of claim 10, wherein the modularity score for a connectivity graph characterizes a connectivity between pairs of nodes in the graph relative to a connectivity between pairs of nodes in a randomly-connected graph.

12. The method of claim 10, wherein determining the plurality of candidate connectivity graphs based on the first node comprises iteratively performing operations until a termination criterion is satisfied, the operations comprising:
identifying a second node in the connectivity graph, wherein the first node and the second node are connected by an edge;
removing the edge that connects the first node to the second node and connecting all edges that connect the first node to the other nodes in the connectivity graph to the second node;
generating the connectivity graph for the iteration; and
determining if the termination criterion is satisfied; and
after determining that the termination criterion is satisfied, determining the plurality of candidate connectivity graphs.

13. The method of claim 1, wherein for each of the plurality of candidate neural network architectures, each brain emulation sub-network included in the candidate neural network architecture comprises a plurality of brain emulation parameters that represent synaptic connectivity between a plurality of biological neuronal elements represented by the respective community sub-graph that specifies the architecture of the brain emulation sub-network.

14. The method of claim 13, wherein the plurality of brain emulation parameters define a two-dimensional weight matrix having a plurality of rows and a plurality of columns,
wherein each row and each column of the weight matrix corresponds to a respective biological neuronal element from the plurality of biological neuronal elements, and
wherein each brain emulation parameter in the weight matrix corresponds to a respective pair of biological neuronal elements in the brain of the biological organism, the pair comprising: (i) the biological neuronal element corresponding to a row of the brain emulation parameter in the weight matrix, and (ii) the biological neuronal element corresponding to a column of the brain emulation parameter in the weight matrix.

15. The method of claim 14, wherein each brain emulation parameter of the weight matrix has a respective value that characterizes synaptic connectivity in the brain of the biological organism between the respective pair of biological neuronal elements corresponding to the brain emulation parameter.

16. The method of claim 15, wherein each brain emulation parameter of the weight matrix that corresponds to a respective pair of biological neuronal elements that are not connected by a synaptic connection in the brain of the biological organism has value zero.

17. The method of claim 15, wherein each brain emulation parameter of the weight matrix that corresponds to a respective pair of biological neuronal elements that are connected by a synaptic connection in the brain of the biological organism has a respective non-zero value characterizing an estimated strength of the synaptic connection.

18. The method of claim 15, wherein each brain emulation parameter of the weight matrix that corresponds to a respective pair of biological neuronal elements that are connected by a synaptic connection in the brain of the biological organism has a respective non-zero value that is based on a proximity of the pair of biological neuronal elements in the brain.

19. A system comprising:
one or more computers; and
one or more storage devices communicatively coupled to the one or more computers, wherein the one or more storage devices store instructions that, when executed by the one or more computers, cause the one or more computers to perform operations comprising:
obtaining data defining a connectivity graph that represents synaptic connectivity between a plurality of biological neuronal elements in a brain of a biological organism, wherein the connectivity graph comprises: (i) a plurality of nodes, and (ii) a plurality of edges that each connect a respective pair of nodes;
determining a partition of the connectivity graph into a plurality of community sub-graphs by performing an optimization that encourages a higher measure of connectedness between nodes included within each community sub-graph relative to nodes included in different community sub-graphs; and
selecting a neural network architecture for performing a machine learning task using the plurality of community sub-graphs determined by the optimization that encourages the higher measure of connectedness between nodes included within each community sub-graph relative to nodes included in different community sub-graphs, comprising:
instantiating a plurality of candidate neural network architectures, wherein each candidate neural network architecture includes one or more brain emulation sub-networks that each have a respective architecture specified by a respective community sub-graph of the plurality of community sub-graphs;
determining a respective performance measure of each of the plurality of candidate neural network architectures on the machine learning task; and
selecting the neural network architecture for performing the machine learning task based on the performance measures of the plurality of candidate neural network architectures.

20. One or more non-transitory computer storage media storing instructions that when executed by one or more computers cause the one or more computers to perform operations comprising:
obtaining data defining a connectivity graph that represents synaptic connectivity between a plurality of biological neuronal elements in a brain of a biological organism, wherein the connectivity graph comprises: (i) a plurality of nodes, and (ii) a plurality of edges that each connect a respective pair of nodes;
determining a partition of the connectivity graph into a plurality of community sub-graphs by performing an optimization that encourages a higher measure of connectedness between nodes included within each community sub-graph relative to nodes included in different community sub-graphs; and
selecting a neural network architecture for performing a machine learning task using the plurality of community sub-graphs determined by the optimization that encourages the higher measure of connectedness between nodes included within each community sub-graph relative to nodes included in different community sub-graphs, comprising:
instantiating a plurality of candidate neural network architectures, wherein each candidate neural network architecture includes one or more brain emulation sub-networks that each have a respective architecture specified by a respective community sub-graph of the plurality of community sub-graphs;
determining a respective performance measure of each of the plurality of candidate neural network architectures on the machine learning task; and
selecting the neural network architecture for performing the machine learning task based on the performance measures of the plurality of candidate neural network architectures.
